(19) United States
(12) Patent Application Publication
(10) Pub. No.: US 2026/0352285 A1
(43) Pub. Date: Nov. 5, 2026

(54) METHODS, ARCHITECTURES, APPARATUSES AND SYSTEMS TO ENHANCE COORDINATED BEAMFORMING IN Wi-Fi

(71) Applicant: InterDigital Patent Holdings, Inc., Wilmington, DE (US)

(72) Inventors: Mahmoud Saad, Montreal (CA); Ying Wang, Easton, PA (US); Hanqing Lou, Syosset, NY (US); Alphan Sahin, Columbia, SC (US); Rui Yang, Melville, NY (US)

(21) Appl. No.: 19/193,104

(22) Filed: Apr. 29, 2025

(51) Int. Cl. H04B 7/06; H04B 7/024; H04L 1/08; H04W 24/08; H04W 72/0446

(52) U.S. Cl. CPC H04B 7/0626; H04B 7/024; H04L 1/08; H04W 24/08; H04W 72/0446

(57) ABSTRACT

Methods, apparatuses, and systems related to coordinated beamforming in Wi-Fi are provided. One method may include a first access point (AP) transmitting, to a second AP, a first null data packet announcement (NDPA) frame that indicates information for soliciting a first null data packet (NDP) frame transmission. The method may include receiving, from the second AP, a second NDPA frame that includes an indication of received channel state information (CSI) status for at least one station (STA) associated with the first AP. The indication of received CSI status may include or may be an indication of whether CSI measurement information, associated with a first CSI, is obtained at the second AP based on the first NDP transmission by the second AP to the at least one STA associated with the first AP.

### FIELD

Example embodiments described in the present disclosure are generally directed to the fields of communications, software and encoding, including, for example, to methods, architectures, apparatuses, systems related to coordinated beamforming in Wi-Fi.

### BACKGROUND

IEEE 802.11 Ultra High Reliability (UHR) explores the possibility to improve reliability, support further reduced low latency traffic, further increase peak throughput, improved power saving capabilities and improve efficiency of the IEEE 802.11 networks. Multi-AP Coordination (MAPC) is a new feature in UHR which defines several modes of coordination schemes including Coordinated Spatial Reuse (CoSR) and Coordinated Beamforming (CoBF).

### SUMMARY

Certain embodiments may be directed to a first access point (AP) that may include circuitry, such as a processor and/or transceiver, configured to transmit, to a second AP, a first null data packet announcement (NDPA) frame that indicates information for soliciting a first null data packet (NDP) frame transmission from the second AP, and to receive, from the second AP, a second NDPA frame that includes an indication of received channel state information (CSI) status for at least one station (STA) associated with the first AP.

In an embodiment, the indication of received CSI status may include an indication of whether CSI measurement information, associated with a first CSI, is obtained at the second AP based on the first NDP transmission by the second AP to the at least one STA associated with the first AP.

In an embodiment, based on the indication of received CSI status, the first AP may be configured to re-transmit the first NDPA including an indication that it is a retransmission of the first NDPA.

In an embodiment, the first AP may be configured to transmit, to the at least one STA, a trigger frame to trigger the at least one STA to send the first CSI based on the first NDP transmission.

In an embodiment, the first AP may be configured to transmit, to the second AP, a coordinated beamforming invite frame including first information inviting the second AP to participate in coordinated beamforming with the first AP, and to receive, from the second AP, a coordinated beamforming response frame including second information indicating a reason for rejection of participation in the coordinated beamforming with the first AP.

In an embodiment, the first AP may be configured to receive, from the second AP, a coordinated beamforming invite frame including third information inviting the first AP to participate in coordinated beamforming with the second AP, and transmit, to the second AP, a coordinated beamforming response frame including fourth information indicating that CSI measurement information, associated with a second CSI, was not obtained at the first AP based on a second NDP transmission by the first AP to the at least one STA associated with the second AP.

In an embodiment, the first AP may be configured to send a CoBF sounding invitation to the second AP, and to receive, from the second AP, a CoBF sounding response including any of: first information indicating a requested frequency associated with receiving the CoBF sounding invitations (e.g., a maximum number of CoBF sounding invitations to be received during a time period), and second information indicating a time after which the second AP can receive the CoBF sounding invitations.

In an embodiment, the CoBF sounding response may indicate a rejection of the CoBF sounding invitation and an indication of a reason for the rejection of the CoBF sounding invitation.

Certain embodiments may be directed to a method, which may be implemented by a first AP. The method may include transmitting, to a second AP, a first null data packet announcement (NDPA) frame that indicates information for soliciting a first null data packet (NDP) frame transmission from the second AP, and receiving, from the second AP, a second NDPA frame that includes an indication of received channel state information (CSI) status for at least one station (STA) associated with the first AP.

In an embodiment, the indication of received CSI status may include an indication of whether CSI measurement information, associated with a first CSI, is obtained at the second AP based on the first NDP transmission by the second AP to the at least one STA associated with the first AP.

In an embodiment, based on the indication of received CSI status, the method may include re-transmitting the first NDPA including an indication that it is a retransmission of the first NDPA (e.g., indication that the first NDPA is to initiate or repeat cross-BSS sounding).

In an embodiment, the method may include transmitting, to the at least one STA, a trigger frame to trigger the at least one STA to send the first CSI based on the first NDP transmission.

In an embodiment, the method may include transmitting, to the second AP, a coordinated beamforming invite frame including first information inviting the second AP to participate in coordinated beamforming with the first AP, and receiving, from the second AP, a coordinated beamforming response frame including second information indicating a reason for rejection of participation in the coordinated beamforming with the first AP.

In an embodiment, the method may include receiving, from the second AP, a coordinated beamforming invite frame including third information inviting the first AP to participate in coordinated beamforming with the second AP, and transmitting, to the second AP, a coordinated beamforming response frame including fourth information indicating that CSI measurement information, associated with a second CSI, was not obtained at the first AP based on a second NDP transmission by the first AP to the at least one STA associated with the second AP.

In an embodiment, the method may include sending a CoBF sounding invitation to the second AP, and receiving, from the second AP, a CoBF sounding response including any of: first information indicating a requested frequency associated with receiving CoBF sounding invitations (e.g., a requested maximum number of CoBF sounding invitations received during a time period), and second information indicating a time after which the second AP can receive the CoBF sounding invitations.

In an embodiment, the CoBF sounding response may indicate a rejection of the CoBF sounding invitation and an indication of a reason for the rejection of the CoBF sounding invitation.

Certain embodiments may be directed to a first access point (AP) that may include circuitry, such as a processor and/or transceiver, configured to receive, from a second AP, a first null data packet announcement (NDPA) frame that indicates information for soliciting a first null data packet (NDP) frame transmission, and to transmit, to the second AP, a second NDPA that includes an indication of received channel state information (CSI) status for at least one station (STA) associated with the second AP.

Certain embodiments may be directed to a method, implemented by a first access point (AP). The method may include receiving, from a second AP, a first null data packet announcement (NDPA) frame that indicates information for soliciting a first null data packet (NDP) frame transmission, and transmitting, to the second AP, a second NDPA that includes an indication of received channel state information (CSI) status for at least one station (STA) associated with the second AP.

In an embodiment, the indication of received channel state information (CSI) status comprises an indication of whether CSI measurement information is obtained at the first AP based on the solicited transmission of the first NDP by the first AP to the at least one STA of the second AP.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates a multi-access point (multi-AP) scenario for coordinating concurrent spatial streams, according to some embodiments;

FIG. 3 illustrates an example of TXOP level CoSR triggering and concurrent transmission, according to certain embodiments;

FIG. 4 illustrates an example of sequential CoBF sounding, according to some embodiments;

FIG. 5 illustrates an example of joint CoBF sounding, according to some embodiments;

FIG. 6 illustrates an example of the three subphases employed in CoBF transmission;

FIG. 7 illustrates an example of a CoBF sounding phase invitation procedure, according to certain embodiments;

FIG. 8 illustrates an example messaging flow diagram depicting a CoBF sounding process, according to some embodiments;

FIG. 9 illustrates an example message flow diagram depicting a procedure for indicating the status of receiving CSI feedback, according to some embodiments;

FIG. 10 illustrates an example diagram of the sequences associated with CoBF sounding, according to some embodiments;

FIG. 11 illustrates an example diagram of the sequences associated with CoBF sounding, according to some embodiments;

FIG. 12 illustrates a message flow diagram depicting the initiation of a cross-BSS sounding sequence, according to an embodiment;

FIG. 13 illustrates an example diagram for initiating a cross-BSS sounding sequence, according to certain embodiments;

FIG. 14 illustrates an example message flow diagram depicting a responding AP initiating a cross-BSS sounding sequence, according to some embodiments;

FIG. 15 illustrates an example diagram for initiating a cross-BSS sounding sequence, according to certain embodiments;

FIG. 16 illustrates an example flow diagram of a method for CoBF sounding, according to some embodiments;

FIG. 17 illustrates an example flow diagram of a method for CoBF sounding, according to some embodiments;

FIG. 18 illustrates an example flow diagram of a method for CoBF sounding, according to some embodiments;

FIG. 19 illustrates an example diagram of cross-BSS sounding sessions in the same TXOP, according to an embodiment;

FIG. 20 illustrates an example diagram of cross-BSS sounding sessions in different TXOPs, according to an embodiment;

FIG. 21 illustrates an example diagram of cross-BSS sounding sessions in different TXOPs, according to an embodiment;

FIG. 22 illustrates an example flow diagram of a method for performing cross-BSS sounding sequences in the same TXOP, according to some embodiments;

FIGS. 23A and 23B illustrate example flow diagrams of a method for performing cross-BSS sounding sequences in the two different TXOPs, according to some embodiments;

FIG. 24 illustrates an example CoBF sequential sounding sequence, according to some embodiments;

FIG. 25 illustrates an example CoBF sequential sounding sequence, according to some embodiments;

FIG. 26 illustrates an example CoBF joint sounding sequence, according to some embodiments;

FIG. 27 illustrates a flow diagram of a method for CoBF joint sounding, according to some embodiments;

FIG. 28 illustrates an example NAV setting for the CoBF sequential sounding procedure, according to some embodiments;

FIG. 29 illustrates an example diagram of a NAV setting for a CoBF joint sounding procedure, according to some embodiments; and

FIG. 30 illustrates an example flow diagram of a method relating to CoBF, according to some embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

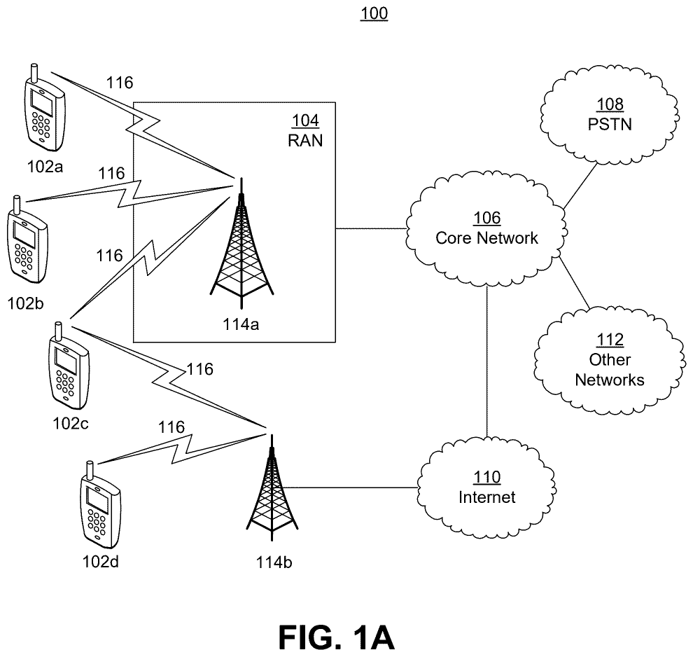

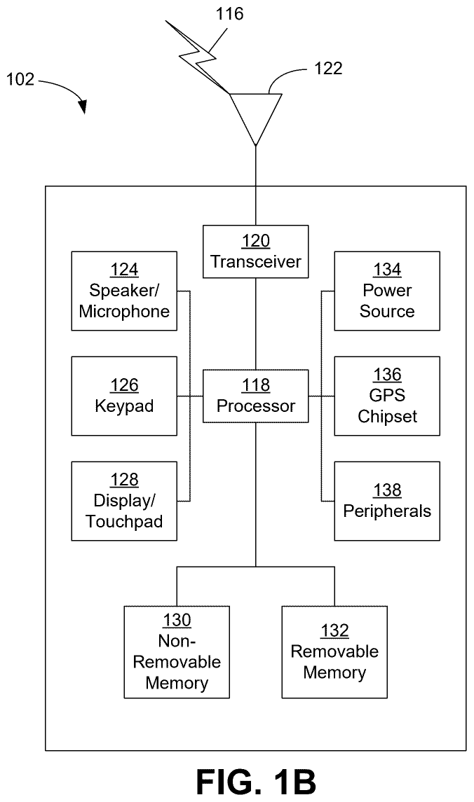

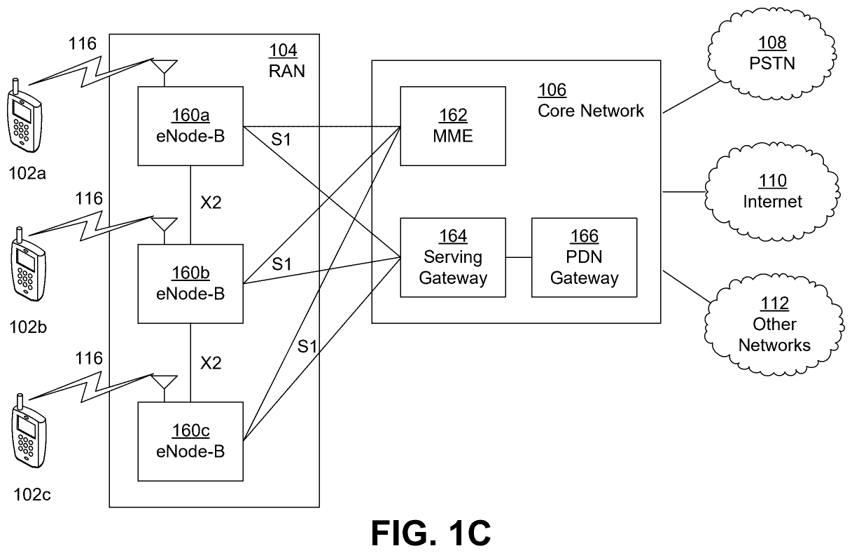

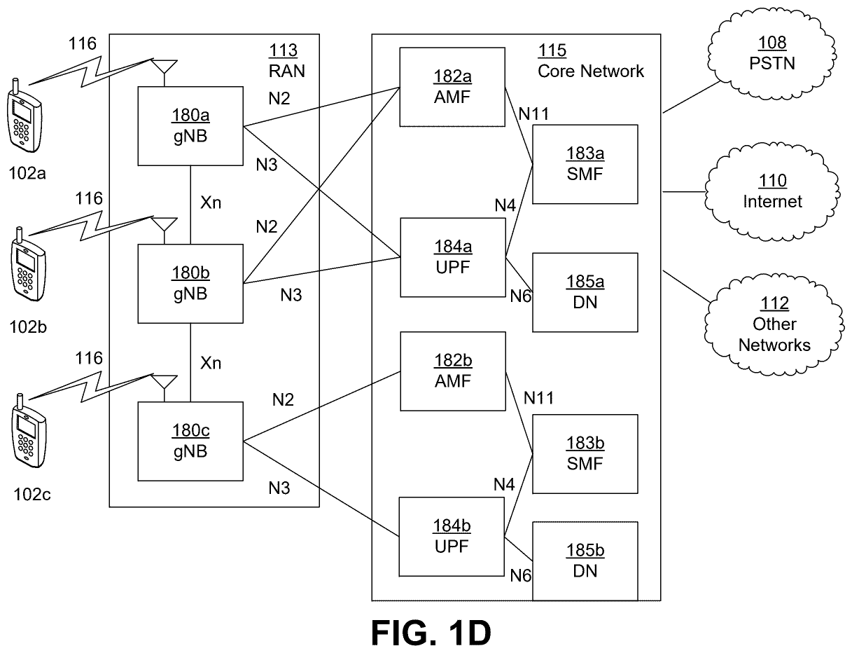

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discrete Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device (e.g. gaming device), a device operating on commercial and/or industrial wireless networks, and the like. Any of the WTRUs 102a, 102b, 102c and 102d, or any other WTRU mentioned or described herein, may be interchangeably referred to as a UE or vice versa.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing an NR radio technology, the CN 106 may also be in communication with another RAN (not shown) employing any of a GSM, UMTS, CDMA 2000, WiMAX, E-UTRA, or Wi-Fi radio technology.

The CN 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements or peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements or peripherals 138, which may include one or more software and/or hardware modules or units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be any one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, a humidity sensor, or the like.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP (e.g., See IEEE Std 802.11™—2020: Wireless LAN Medium Access Control (MAC) and Physical Layer (PHY) Specifications). The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

An AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off for a certain period of time before sensing again. One STA (e.g., only one station) may transmit at any given space, time and frequency resource in a given BSS.

In an embodiment, an AP may assign bandwidth resources over which associated STAs communicate with the AP. Bandwidth resources may include one or more channels (i.e., contiguous, or non-contiguous), one or more subchannels within a channel, one or more resource units (RUs) within an Orthogonal Frequency division Multiple Access (OFDMA) system, whereby assigned one or more RUs may be adjacent (i.e., contiguous) or non-contiguous, occupying one or more channels or subchannels, etc.

High Throughput (HT or 802.11n) STAs may use a 40 MHz wide channel for communication, for example, via a combination of the primary 20 MHz channel with an adjacent or nonadjacent 20 MHz channel to form a 40 MHz wide channel.

Very High Throughput (VHT or 802.11ac) STAs may support 20 MHz, 40 MHz, 80 MHz, and/or 160 MHz wide channels transmitted over a 5 GHz frequency band using OFDMA (e.g., See IEEE P802.11ax™/D8.0: Wireless LAN Medium Access Control (MAC) and Physical Layer (PHY) Specifications). The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

High Efficiency Wireless (HEW or 802.11ax) STAs may support 20 MHz, 40 MHz, 80 MHz, and/or 160 MHz wide channels capable of transmission over 2.4 GHz, 5 GHz, and 6 GHz frequency bands using both OFDMA and multi-user multiple-input multiple-output (MU-MIMO) capabilities. OFDMA subcarrier modulation in HE STAs includes formats such as BPSK, QPSK, 16-QAM, 64-QAM, 256-QAM, 1024-QAM. The evolution of 802.11 to Extremely High Throughput (EHT) STAs extends to having 320 MHz wide channels.

While earlier generation 802.11 STAs (e.g., HEW or 802.11ax) could decide to transmit on one of the 2.4, 5.0, or 6 GHz bands, EHT STAs are further capable of multi-link operation (MLO), whereby data transmission between an EHT AP and non-AP STAs can occur over multiple bands simultaneously (e.g., 5 GHz and 6 GHz) thus increasing throughput and/or reliability. EHT STAs also benefit from a jump in QAM modulation from 1024-QAM to 4K-QAM, while enabling peak data rates of around 46 Gbps compared to the 9.6 Gbps capabilities of HEW STAs.

Sub 1 GHz modes of operation are supported by 802.11af and 802.11ah (e.g., See IEEE P802.11-REVme™/D5.0, Wireless LAN Medium Access Control (MAC) and Physical Layer (PHY) Specifications, February 2024). For these specifications the channel operating bandwidths, and the number of OFDM subcarriers, are reduced relative to those used in 802.11n and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. A possible use case for 802.11ah is support for Meter Type Control (MTC) devices in a macro coverage area. MTC devices may have limited capabilities with limited bandwidths, but they may require a very long battery life.

WLAN systems that support multiple channels and channel widths, such as 802.11n, 802.11ac, 802.11af, 802.11ah, 802.11ax, and 802.11be, include a channel that is designated as the primary channel. The primary channel may, but not necessarily, have a bandwidth equal to the largest common operating bandwidth supported by all STAs in the BSS. The bandwidth of the primary channel may therefore be limited by the STA that supports the smallest bandwidth operating mode in the BSS. In the example of 802.11ah, the primary channel may be 1 MHz wide if there are STAs (e.g., MTC type devices) that only support a 1 MHz mode even if the AP, and other STAs in the BSS, may support 2 MHz, 4 MHz, 8 MHz, 16 MHz, or other channel bandwidth operating modes. The carrier sensing and NAV settings depend on the status of the primary channel, i.e., if the primary channel is busy, for example, due to a STA supporting only a 1 MHz operating mode is transmitting to the AP, then the entire available frequency bands may be considered busy even though majority of it stays idle and available.

The next generation of 802.11 standard, 802.11bn (i.e., Ultra High Reliability—UHR) explores the possibility to improve reliability, support further reduced low latency traffic, further increase peak throughput, improved power saving capabilities and improve efficiency of the IEEE 802.11 network over HEW and EHT. These improvements are driven by technological advancements such as 360 immersive video, ultra-high-resolution streaming, online gaming, remote surgery, rapid expansion of Internet of Things (IoT), etc. Other 802.11 standard development examples are directed to areas such as: the application and management of artificial intelligence and machine learning (AIML) in WLANs, expanding WiFi communications into the millimeter-wave frequency band (integrated millimeter-wave—IMMW), energy harvesting based on of WiFi RF signals for facilitating WLAN communications of low-power IoT devices, and the randomization of MAC addresses in WLANs.

Embodiments disclosed herein are representative and do not limit the applicability of the apparatus, procedures, functions and/or methods to any particular wireless technology, any particular communication technology and/or other technologies. The term “network” in this disclosure may generally refer to one or more base stations, gNBs, access points, or other network entities which in turn may be associated with one or more Transmission/Reception Points (TRPs), or to any other node in the radio access network.

As introduced above, UHR explores the possibility to improve reliability, further reduce low latency traffic, further increase peak throughput, improve power saving capabilities and improve efficiency of the IEEE 802.11 networks. Multi-AP Coordination (MAPC) is a new feature in UHR which defines several modes of coordination schemes including Coordinated Spatial Reuse (CoSR) and Coordinated Beamforming (CoBF).

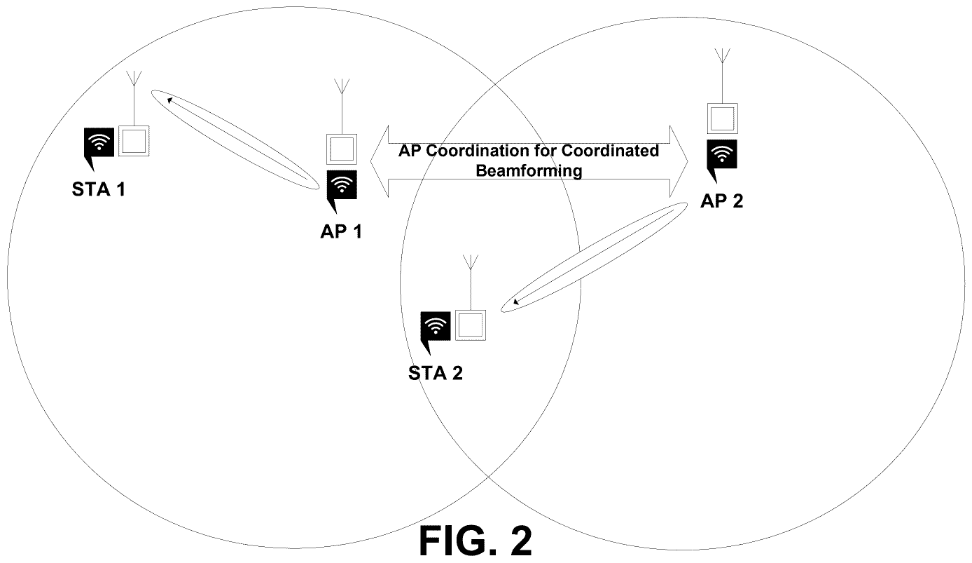

FIG. 2 illustrates a multi-access point (multi-AP) scenario for coordinating concurrent spatial streams, according to some embodiments. Accordingly, as illustrated in the example of FIG. 2, AP1 may include data for transmission to associated STA 1 and AP2 may include data for transmission to associated STA 2. In order to establish the ability for both AP1 and AP2 to spatially transmit their respective data streams concurrently (e.g., partially or completely overlapping in time), both APs may exchange communications with each other and their associated STAs according to the example embodiments described below.

802.11bn defines multi-AP Coordinated Spatial Reuse (CoSR) at transmit opportunity (TXOP)-level with power control. Its objectives include to allow more efficient medium usage by concurrent transmissions of multiple APs using transmit power control. The CoSR transmission is initiated by an AP that obtains a TXOP and becomes the initiating or sharing AP. The sharing AP transmits a Trigger frame to the participating or shared AP identified by the AP ID carried in the AID12 field of the User Info field of the Trigger frame to initiate the concurrent CoSR transmission. 802.11bn limits the concurrent CoSR transmission to the sharing AP and the shared AP (e.g., only one shared AP). A short interval after the Trigger Frame, the two APs may simultaneously start to transmit their respective data physical layer protocol data units (PPDUs) during the concurrent CoSR transmission. The duration of the two ensuing data PPDUs are the same as well. In addition, 802.11bn limits both data PPDUs to be downlink (DL) single-user (SU) PPDUs and the maximum number of spatial streams transmitted by each AP in CoSR to 4. Moreover, 802.11bn defines two modes for the concurrent CoSR transmission. In Mode 1, at least one of the two data PPDUs during the concurrent CoSR transmission could be an EHT PPDU. The format of the two data PPDUs could be a combination of UHR+EHT, EHT+UHR, or EHT+EHT. Both PPDUs have the same non-high-throughput signal field (e.g., legacy signal (L-SIG)) content. In Mode 2, both data PPDUs are UHR PPDUs that have the same L-SIG and universal signal field (U-SIG) contents. Also, in Mode 2, the short interval between the end of the Trigger Frame and the two concurrent UHR data PPDUs is short interframe space (SIFS).

It is noted that, as used herein, a “sharing AP” may refer to an AP that has acquired a TXOP and is willing or able to share it with one or more APs using a certain coordination scheme (e.g., CoBF). Further, as used herein, a “shared AP” may refer to an AP that is invited or requested to share a TXOP with another AP (e.g., sharing AP).

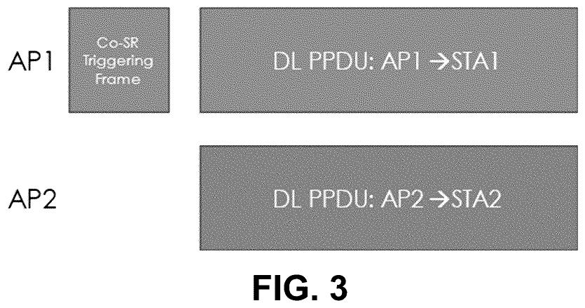

FIG. 3 illustrates an example of TXOP level CoSR triggering and concurrent transmission, according to certain embodiments. As illustrated in the example of FIG. 3, the CoSR transmission may be initiated by AP1 that obtains a TXOP and becomes the initiating AP or the sharing AP. To initiate CoSR transmission, the sharing AP1 may transmit a CoSR Trigger frame to the shared AP2, which may be identified by the AP ID carried in the AID12 field of the User Info field of the Trigger frame. AP1 and AP2 may then transmit their respective DL PPDUs to STA1 or STA2. [0121]802.11bn has defined coordinated beamforming (CoBF) as a technique which can be used by multiple APs, each with multiple antennas (e.g., acting as a beamformer), to steer signals using knowledge of the channel in order to improve throughput, improve reliability, and/or to reduce latency. An objective of CoBF is to allow more efficient medium usage by enabling concurrent transmissions of two APs with multiple antennas to each AP's associated STAs while minimizing interference to overlapping basic service set (OBSS) STAs by using the channel state information (CSI) of the channels between each AP and the recipient STAs of the other AP of the CoBF transmission. Under the current definition of CoBF, the number of participating APs in a CoBF transmission is 2 with a maximum of 4 recipient STAs across the two APs, the maximum number of spatial streams per recipient STA in CoBF is 2, and the maximum number of spatial streams across the two APs participating in CoBF is limited to 4. However, it should be noted that example embodiments described herein are not limited to these number of APs, STAs, and/or spatial streams.

In SU-MIMO beamforming, the spatial streams (e.g., all spatial streams) in the transmitted signal are intended for reception at a single STA; while in DL MU-MIMO beamforming, disjoint subsets of the spatial streams are transmitted from a single AP and are intended for reception at different non-AP STAs. Differently, in CoBF, disjoint subsets of spatial streams are transmitted from different APs, where each AP's subset of streams may be further divided into the streams intended for reception at one or more non-AP STAs associated with that AP.

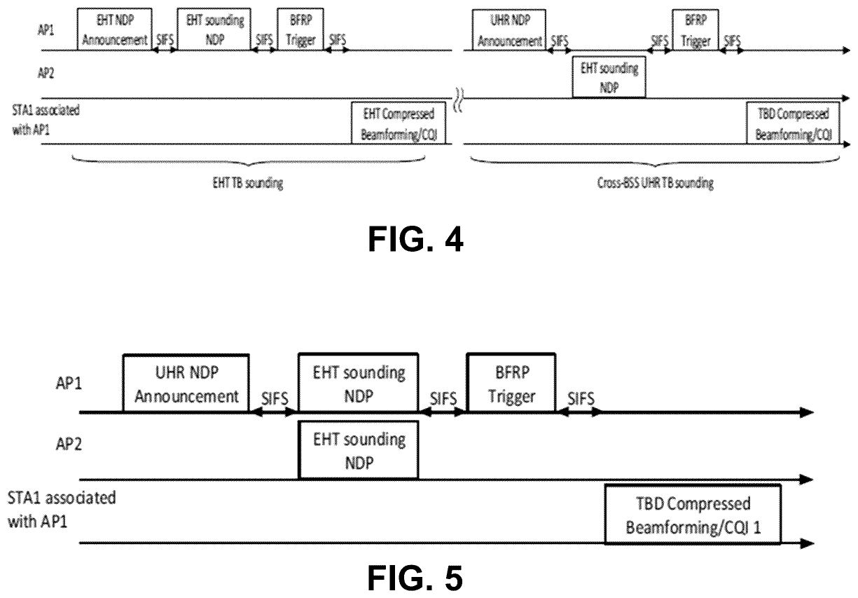

CoBF may be performed in two phases, a CoBF sounding phase and a CoBF data transmission phase. The CoBF sounding phase may be performed frequently (e.g., every 50 ms) while the CoBF data transmission phase may be performed by the sharing AP when it acquires the TXOP. Two CoBF sounding schemes are supported in UHR: sequential CoBF Sounding (e.g., see FIG. 4) and joint CoBF Sounding (e.g., see FIG. 5). FIG. 4 illustrates an example of sequential CoBF sounding, according to some embodiments. As illustrated in the example of FIG. 4, AP1 may initiate UHR TB sequential NDP sounding sequence. FIG. 5 illustrates an example of joint CoBF sounding, according to some embodiments. In the example of FIG. 5, AP1 may initiate UHR TB joint NDP sounding sequence. In both schemes (e.g., in FIG. 4 and FIG. 5), the same sequence initiated by AP1 is later initiated by AP2 subsequently after a SIFS.

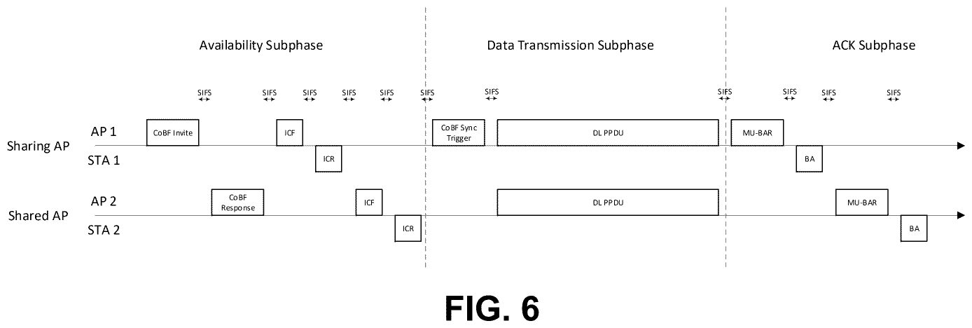

The transmission phase in coordinated transmission schemes, such as CoBF and CoSR, can be divided into three subphases, the availability subphase, the transmission subphase, and the acknowledgement or ACK subphase, as illustrated in the example of FIG. 6 discussed below. In the availability subphase, the sharing AP may invite the shared AP for coordinated transmission (e.g., CoBF) to check its availability for the coordinated transmission. Further, the sharing AP and shared AP (e.g., both the sharing and shared AP) may poll their selected STAs to participate in the coordinated transmission. In the data transmission subphase, the sharing AP may trigger the concurrent PPDU transmission of both the sharing AP and the shared AP. Finally, in the ACK subphase, both the sharing AP and the shared AP may solicit the ACK from their respective STAs which participated in the coordinated transmission (e.g., CoBF).

FIG. 6 depicts an example of the three subphases employed in CoBF transmission. That is, FIG. 6 illustrates an example frame exchange sequence of the transmission phase in CoBF. As illustrated in the example of FIG. 6, in the availability subphase, AP1 (e.g., sharing AP) sends a CoBF Invite frame to AP2 (e.g., shared AP). AP2 may respond with a CoBF Response frame, e.g., with a status code to indicate whether it accepts or rejects the invitation. If AP2 is available and accepts the invitation, AP1 may send an Initial Control Frame (ICF) to its STAs, e.g., STA1. If STA1 is available, it may respond with an Initial Control Response frame (ICR) to AP1. Then, AP2 may send an Initial Control Frame (ICF) to its STAs, e.g., STA2. If STA2 is available, it may respond with an Initial Control Response frame (ICR) to AP2. In the data transmission subphase, AP1 (e.g., the sharing AP) may send a CoBF Sync Trigger frame to synchronize the coordinated beamformed data transmission from AP1 to STA1 while nulling towards STA2 and from AP2 to STA2 while nulling towards STA1. Finally, in the ACK subphase, AP1 may send a Multi-User Block ACK Request (MU-BAR) to its STAs (e.g., STA1) to solicit a Block ACK response (BA) and AP2 sends a Multi-User Block ACK Request (MU-BAR) to its STAs (e.g., STA2) to solicit a Block ACK response (BA).

A responding AP may receive frequent CoBF sounding invitation(s) from different inviting APs for which it is not ready to engage in CoBF sounding. Signaling and/or behavior to enable a responding AP to control the frequency of receiving CoBF sounding invitation(s) or the time in which these invitations arrive are currently lacking in WiFi.

The cross BSS reception of CSI measured by a STA associated to an AP and received by the other AP in the CoBF MAPC group may not be received correctly for various reasons. Indications and/or behaviour which allows the APs performing the CoBF sounding to determine whether the CSI feedback is received correctly or not is currently lacking in WiFi.

An AP may fail to receive the cross BSS CSI because of interference from a hidden node. It would be beneficial to have a procedure to protect the TXOP in which the CoBF sounding session takes place.

As will be discussed in more detail below, example embodiments may provide approaches to address at least the problems and/or issues outlined above. For example, certain embodiments may provide a procedure to control the frequency of receiving CoBF sounding invitations, a procedure for the indication of CSI reception failure and/or a procedure for the mitigation of CSI reception failure.

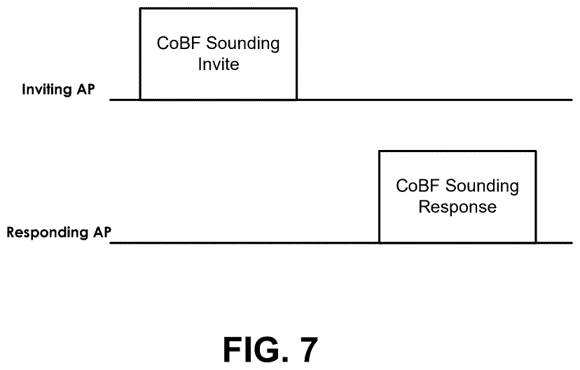

Some embodiments may include procedure(s) to control the frequency of receiving CoBF sounding invitations. FIG. 7 illustrates an example of a CoBF sounding phase invitation procedure, according to certain embodiments. As illustrated in the example of FIG. 7, prior to the CoBF sounding phase, an inviting AP may send a CoBF Sounding Invite to a responding AP. The responding AP may then respond with a CoBF Sounding Response to accept or decline the CoBF sounding invitation. This sequence can be used to exchange the sounding capabilities of the participating STAs, negotiate the CoBF sounding roles and/or control the CoBF sounding operation.

The responding AP may receive multiple invitations from different inviting APs for which it is not ready to engage in CoBF sounding and this may impact the availability of the responding access point. The responding access point may accept or decline the invitations coming from different inviting access points.

In one embodiment, the responding AP may indicate, to the inviting AP, the frequency of CoBF sounding invitations (e.g., the maximum number of CoBF sounding invitations to be received during a time period) it can receive. For example, the responding AP may indicate to the inviting AP, e.g., in a field in the CoBF Response frame, a requested frequency at which it is able to (or would like to) receive the CoBF sounding invitation(s). Alternatively or additionally, in an embodiment, the responding AP may indicate to the inviting AP, e.g., in another field in the CoBF Response frame, a time in which (or after which) it will be ready to receive the next CoBF sounding invitation(s).

In some embodiments, the field to indicate the frequency of CoBF sounding invitations a responding AP can receive and/or the field to indicate the time in which the responding AP may be ready to receive the next CoBF sounding invitation, can be sent in the CoBF Sounding Response, e.g., whether the responding AP accepts or declines the CoBF Sounding invitation.

In one embodiment, the CoBF Sounding Response may include at least one of two fields to control the frequency and/or the time in which it receives invitations for CoBF sounding as shown in Table 1 below. For example, the first field may be named “Time To Receive Invitations” and the second field may be named “Frequency of Invitations.”

TABLE 1
Example Fields of CoBF Sounding Response

| | |
|---|---|
| Time to Receive | Frequency of Invitations |
| Invitations | |

In one embodiment, the encoding of the Time To Receive Invitations field may be a 3-bit encoding in which the responding AP indicates the time it is ready to accept the next CoBF sounding invitation as shown in Table 2 below. In one example, the value 0 indicates that the responding AP may accept the next CoBF sounding invitation if it receives it after 50 ms. In another example, the value 1 indicates that the responding AP may accept the next CoBF sounding invitation if it receives it after 100 ms, and so on and so forth.

TABLE 2
Example of 3-bit Encoding of Time to Receive Invitations Field

| | Meaning |
|---|---|
| | (time in |
| Value | milliseconds) |
| 0 (000) | 50 ms |
| 1 (001) | 100 ms |
| 2 (010) | 150 ms |
| 3 (011) | 200 ms |
| 4 (100) | 250 ms |
| 5 (101) | 500 ms |
| 6 (110) | 750 ms |
| 7 (111) | 1000 ms |

In an embodiment, the encoding of the Frequency of Invitations field may be a 3-bit encoding in which the responding AP indicates the frequency of CoBF sounding invitations it is ready to accept as shown in Table 3 below. In one example, the value 0 indicates that the responding AP may accept the CoBF sounding invitations at a rate of 20 times per second. In another example, the value 1 indicates that the responding AP may accept the CoBF sounding invitations at a rate of 10 times per second, and so on and so forth.

TABLE 3
Example 3-bit Encoding of Frequency of Invitations Field

| | Meaning |
|---|---|
| | (Frequency |
| Value | per second) |
| 0 (000) | 20 |
| 1 (001) | 10 |
| 2 (010) | 5 |
| 3 (011) | 4 |
| 4 (100) | 2 |
| 5 (101) | 1 |
| 6 (110) | Reserved |
| 7 (111) | Reserved |

According to an embodiment, Table 4 lists a 3-bit encoding example for the Reason for Rejection field in the Control field in the CoBF Sounding Response frame in the Sounding Phase. For example, the Rejection Code of a value 0 may be used to reject the invitation for CoBF sounding due to too many requests are received either from the same AP or from different APs. As another example, the Rejection Code with value 1 may be used to reject the invitation for CoBF Sounding, for instance, because the CSI is still usable and there is no need to repeat the sounding. As another example, the Rejection Code with value 2 may be used to reject the invitation for CoBF sounding due to the lack of selected candidates for CoBF sounding. Other values may be reserved for other rejection reason indications.

TABLE 4
Example Listing of 3-bit Encoding for a Reason
of Rejection Field in a Control Field of CoBF
Sounding Response frame in Sounding Phase

| Rejection Code | Rejection Reason |
|---|---|
| 0 | Too Many Requests |
| 1 | No Need To Repeat Sounding |
| 2 | No Selected Candidates |
| 3-7 | Reserved |

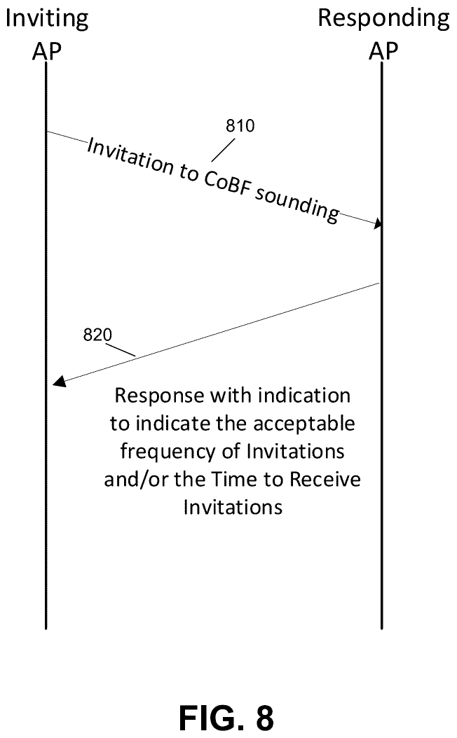

FIG. 8 illustrates an example messaging flow diagram depicting a process between an inviting AP (or initiating AP) and a responding AP in CoBF Sounding, according to some embodiments. In one embodiment, as illustrated in the example of FIG. 8, an inviting AP may send, at 810, a CoBF sounding invitation to the responding AP. In an embodiment, the responding AP, which is invited to a CoBF sounding by the inviting AP, may respond by sending a CoBF Sounding Response at 820. In certain embodiments, the CoBF Sounding Response may include one or more of two fields to indicate or control the frequency of receiving invitations (e.g., the number of invitations that can be received during a time period) and/or a time in which or after which the responding AP receives invitation(s) (e.g., indicating a requested time at which (or after which) to begin receiving invitations) to participate in CoBF sounding sessions. In a further embodiment, the responding AP may respond to the CoBF sounding invitation with a rejection of the CoBF sounding invitation. For example, the responding AP may respond with a status of reject and/or a reason for rejection code set to a value to indicate that too many requests are received as listed in Table 4 above.

In one embodiment, the responding AP may set the Time to Receive Invitations field to a value (for example as listed in Table 2 above) to request the inviting AP to send the next CoBF Sounding Invite after the time indicated in the field Time to Receive Invitations has been passed or expired. The inviting AP may then start a counter in the context of coordination with this specific (responding) AP to guarantee the next invitation will be sent after the requested time (e.g., after the time requested by the responding AP as indicated in the Time to Receive Invitations field).

According to an embodiment, the responding AP may set the Frequency of Invitations field to a value (for example as listed in Table 3 above) to request the inviting AP to limit the frequency of sending CoBF sounding invitations to an upper bound that is set by the value indicated in the Frequency of Invitations field. The inviting AP may then run essential procedures to guarantee that the frequency of sending the CoBF sounding invitations to this specific (responding) AP may not exceed the limit indicated by the Frequency of Invitations field.

Some embodiments may include procedures for the indication of CSI reception failure. In sequential CoBF sounding, e.g., as shown in FIG. 4 discussed above, AP1 may start the sounding sequence by sending a null data packet (NDP) Announcement (NDPA) frame to its associated STA(s) including the STA(s) that are participating in this CoBF sounding session (e.g., STA1 in FIG. 4). Then, (e.g., after a SIFS) AP1 may send a NDP followed (e.g., after a SIFS) by a BFRP trigger frame. STAs associated with AP1 (e.g., including STA1) may then respond (e.g., after a SIFS) with a beamforming feedback report (e.g, CSI). This part of the CoBF sounding sequence may be called the in-BSS sounding in which an AP participating in a CoBF sequence performs sounding for its associated STAs.

As further illustrated in FIG. 4, AP1 may then send another NPDA that is followed by an NDP transmitted from AP2 and received by the STAs associated with AP1 that are participating in this CoBF sounding session (e.g., STA1 in FIG. 4). After a SIFS, AP1 may then send a BFRP trigger frame that is followed by a beamforming feedback report sent from STA1 and overheard (e.g., received) by AP2. This part of the CoBF sounding sequence may be called the cross-BSS sounding in which an AP participating in a CoBF sequence performs sounding for STAs associated with other APs which potentially will participate in a CoBF transmission session with this AP. In this example, AP1 is the AP which invited the other AP (i.e., AP2) to the CoBF sounding session and may be called the inviting AP, initiating AP or Initiator. AP2 is the AP that has been invited to the CoBF sounding session and may be called the invited AP, responding AP or Responder.

The same sequence outlined above (e.g., the in-BSS sounding and cross-BSS sounding) may be repeated after a period of time but with AP2 taking the lead by transmitting the NDPA. For example, AP2 may start its part of the CoBF sequential sounding by sending a NDPA frame to its associated STA(s) including the STA(s) that are participating in this CoBF sounding session (e.g., STA2). Then, (e.g., after a SIFS) AP2 sends an NDP followed (after a SIFS) by a BFRP trigger frame. STAs associated with AP2 (including STA2) may respond (e.g., after a SIFS) with a beamforming feedback report (e.g. CSI). This part of the CoBF sounding sequence may be called the in-BSS sounding in which an AP participating in a CoBF sequence performs sounding for its associated STAs.

AP2 may then send another NPDA which is followed by an NDP transmitted from AP1 and received by the STAs associated with AP2 that are participating in this CoBF sounding session (e.g., STA2). After a SIFS, AP2 may send a BFRP trigger frame that may be followed by a beamforming feedback report sent from STA2 and overheard (e.g., received) by AP1. This part of the CoBF sounding sequence may be called the cross-BSS sounding in which an AP participating in a CoBF sequence performs sounding for STAs associated with other APs which potentially will participate in a CoBF transmission session with this AP.

The sequence of operation in CoBF sequential sounding (i.e., in-BSS sounding and cross-BSS sounding) may be reordered such that cross-BSS sounding is performed before in-BSS sounding. Also, the sequence of operation may be reordered such that AP2 performs its part of the CoBF sounding (e.g., in-BSS and/or cross-BSS sounding) before AP1. Further, the sequence of operation in CoBF sequential sounding (i.e., in-BSS sounding and cross-BSS sounding) can be performed in the same TXOP or in different TXOPs. Further, the in-BSS sounding and cross-BSS sounding for the same AP may be performed jointly (i.e., in the same TXOP) or disjointly (i.e., in separate TXOPs). Further, the cross-BSS sounding of AP1 and AP2 may be performed jointly (i.e., in the same TXOP) or disjointly (i.e., in separate TXOPs).

The cross-BSS part of the sequential CoBF sounding is prone to failures and therefore it may be useful to provide a procedure such that the AP receiving the CSI feedback (e.g., beamforming feedback) in a cross-BSS sounding can indicate early whether the reception of the cross-BSS sounding CSI was successful or not (e.g., this may include whether the CSI was received and/or whether measurement information in the CSI was decoded or accessed successfully).

In one embodiment, a field in the NDPA may be used by an AP to indicate to the other AP(s) participating in the CoBF sounding session if it received the CSI feedback successfully or not. It is noted that successful receipt of the CSI may include actually receiving the CSI and/or being able to decode, read or otherwise access measurement information indicated in the CSI. The behavior of one or both APs may then change based on this indication.

Additionally or alternatively, in an embodiment, another field in the NDPA could be used by an AP to indicate to the other AP(s) participating in the CoBF sounding session whether this NDPA is to initiate just the cross-BSS CoBF sounding sequence (e.g., the NDPA may include an indication to indicate or request that only the cross-BSS CoBF sounding sequence should be initiated). This field may cut the overhead of repeating the entire CoBF sequence to just the overhead needed to repeat the missed cross-BSS sounding part.

In an embodiment, a field (e.g., which may be named CSI Feedback Status or the like) may be defined in the STA Info field of the responding AP (e.g., the second STA Info field) in the UHR NDP Announcement frame for CoBF Sounding. This field may be used by an AP to indicate whether the reception of the cross-BSS sounding part of a CoBF sequential sounding succeeded or failed. Table 5 below illustrates an example of a STA Info field that may include the newly defined field (e.g., CSI Feedback Status field). According to certain embodiments, this field may be otherwise included in a common information field in the NDPA, in a different STA Info field, or in another reserved bit in the responding AP STA Info field.

In some embodiments, the field (e.g., CSI Feedback Status field) may be set to a value (such as 0) to indicate that the cross-BSS CSI feedback of the cross-BSS sounding immediately performed before sending this NDPA is not received correctly. The field (e.g., CSI Feedback Status field) may be set to a different value (such as 1) to indicate that the cross-BSS CSI feedback of the cross-BSS sounding immediately performed before sending this NDPA is received correctly.

TABLE 5
Example of STA Info Field in the UHR NDPA frame for CoBF Sounding

| B0-B10 | B11-B15 | B16 | B17 | B18 | B19 | B20-B24 | B25 | B26 | B27 | B28-B31 |
|---|---|---|---|---|---|---|---|---|---|---|
| AID11 | Punctured | Number | Starting | Number | LTF + GI | Recommended | CSI | Reserved | Disambiguation | Reserved |
| | Channel | of EH-LTF | Spatial | of Spatial | Size | MCS for CSI | Feedback | | | |
| | Information | Symbols | Stream | Streams | | Feedback | Status | | | |

In an embodiment, a field (e.g., which may be named Cross-BSS Sounding) may be defined, for example, in the STA Info field of responding AP (e.g., the second STA Info field) in the UHR NDP Announcement frame for CoBF Sounding. This field (e.g., Cross-BSS Sounding field) may be used by an AP to indicate that this NDPA is sent to initiate just a Cross-BSS Sounding sequence (e.g., only the Cross-BSS Sounding should be initiated and not the in-BSS sounding) in which the sending AP is the initiator AP and the receiving AP is the responding AP. Table 6 below illustrates an example STA Info field that may include the newly defined field. This field may be otherwise included in a common information field in the NDPA, in a different STA Info field, or in another reserved bit in the responding AP STA Info field (The second STA Info field).

For example, the field (e.g., Cross-BSS Sounding field) may be set to a value (such as 0) to indicate that this NDPA is sent in a CoBF sounding sequence which includes the in-BSS Sounding sequence and the cross-BSS sounding sequence for the initiating AP. The field (e.g., Cross BSS Sounding field) may be set to a different value (such as 1) to indicate that this NDPA is sent in a CoBF sounding sequence which includes the cross-BSS sequence only for the initiating AP.

TABLE 6
Example of STA Info Field in the UHR NDPA frame for CoBF Sounding

| B0-B10 | B11-B15 | B16 | B17 | B18 | B19 | B20-B24 | B25 | B26 | B27 | B28-B31 |
|---|---|---|---|---|---|---|---|---|---|---|
| AID11 | Punctured | Number | Starting | Number | LTF + GI | Recommended | Cross | Reserved | Disambiguation | Reserved |
| | Channel | of EH-LTF | Spatial | of Spatial | Size | MCS for CSI | BSS | | | |
| | Information | Symbols | Stream | Streams | | Feedback | Sounding | | | |

In an embodiment, a field (e.g., which may be named Reason for Rejection field) may be defined in the CoBF Response frame to indicate a reason to reject the participation in the CoBF transmission phase (e.g., see FIG. 6 depicting the CoBF transmission phase, as discussed above). For example, the field (e.g., Reason for Rejection field) may be defined in a Control field in the CoBF Response frame. The field (e.g., Reason for Rejection field) may be used by an AP to reject participation in a CoBF transmission TXOP, e.g., due to the failure to receive the Cross-BSS CSI feedback in the latest CoBF sounding. According to one embodiment, Table 7 below illustrates a 3-bit encoding example for the field (e.g., Reason for Rejection field) in the Control field in the CoBF Response frame in the Data Transmission Phase. For example, a Rejection Code of a value 0 may be used to reject the invitation for CoBF data transmission, e.g., due to too many requests being received from the same AP and/or from different APs. As another example, a Rejection Code with value 1 may be used to reject the invitation for CoBF data transmission, e.g., due to failure to receive and/or decode the cross CSI successfully. As another example, a Rejection Code with value 2 may be used to reject the invitation for CoBF data transmission, e.g., due to lack of queued traffic for the STAs associated with this AP and participating in CoBF sounding. As another example, a Rejection Code with value 3 may be used to reject the invitation for CoBF data transmission, e.g., due to the lack of selected candidates for CoBF data transmission. Other values may be reserved for other rejection reason indications, for example.

TABLE 7
Example Listing of a 3-bit Encoding for a Reason
for Rejection Field in a Control Field of CoBF
Response frame in Data Transmission Phase

| Rejection Code | Rejection Reason |
|---|---|
| 0 | Too many Requests |
| 1 | Failed to Receive Cross-BSS CSI |
| 2 | No Queued Traffic |
| 3 | No Selected Candidates |
| 4-7 | Reserved |

In an embodiment, a field (e.g., which may be named CSI Feedback Status) may be defined in a Control field in the CoBF Invite frame. This field may be used by a TXOP holder AP to indicate whether the reception of the cross-BSS sounding CSI of the latest CoBF sequential sounding sequence succeeded or failed. For example, the field (e.g., CSI Feedback Status field) may be set to a value (such as 0) to indicate that the cross-BSS CSI feedback of the cross-BSS sounding performed before sending this Invite frame is not received correctly. The field (e.g., CSI Feedback Status field) may be set to a different value (such as 1) to indicate that the cross-BSS CSI feedback of the cross-BSS sounding performed before sending this NDPA is received correctly.

In an embodiment, the Sounding Invite frame may contain a field or information to indicate a CoBF sounding type (e.g., which may be named CoBF Sounding Type field). Table 8 below illustrates an example of the different variants of this field (e.g., CoBF Sounding Type field). In one example, the CoBF Sounding Type variant 0 may indicate that the invitation is for full joint sounding for both initiating and responding APs, the CoBF Sounding Type variant 1 may indicate that the invitation is for joint sounding for the STAs associated with the initiator only and participating in the CoBF data transmission, the CoBF Sounding Type variant 2 may indicate that the invitation is for joint sounding for the STAs associated with responder only and participating in the CoBF data transmission, the CoBF Sounding Type variant 3 may indicate that the invitation is for sequential sounding with the in-BSS part of the sequential sounding comes first in the order, the CoBF Sounding Type variant 4 may indicate that the invitation is for sequential sounding with the cross-BSS part of the sequential sounding comes first in the order, the CoBF Sounding Type variant 5 may indicate that the invitation is for sequential sounding where only cross-BSS sounding is performed for both the initiating AP and the responding AP in the same TXOP, the CoBF Sounding Type variant 6 may indicate that the invitation is for sequential sounding where cross-BSS sounding is performed for the initiating AP only, the CoBF Sounding Type variant 7 may indicate that the invitation is for sequential sounding where cross-BSS sounding is performed for the responding AP only, the CoBF Sounding Type variant 8 may indicate that the invitation is for sequential sounding where cross-BSS and in-BSS sounding is performed for the initiating AP only, and the CoBF Sounding Type variant 9 may indicate that the invitation is for sequential sounding where cross-BSS and in-BSS sounding is performed for the responding AP only.

According to some embodiments, a subset or all of the variants listed in Table 8 may be used by the initiating AP, e.g., in the invitation to CoBF sounding, to indicate to the responding AP the type of sounding that will be performed. This allows the responding AP to prepare accordingly.

TABLE 8
Example Listing of Variants of a Sounding
Type Field in CoBF Sounding Invite

| CoBF Sounding | |
|---|---|
| Type Variant | CoBF Sounding Type |
| 0 | Full Joint Sounding |
| 1 | Joint Sounding for Initiator Only |
| 2 | Joint Sounding for Responder Only |
| 3 | Full Sequential Sounding with in-BSS First |
| 4 | Full Sequential Sounding with cross-BSS First |
| 5 | Full cross-BSS Sounding for Both APs in Same TXOP |
| 6 | cross-BSS Sounding for Initiator Only |
| 7 | cross-BSS Sounding for Responder Only |
| 8 | cross-BSS Sounding with in-BSS for Initiator Only |
| 9 | cross-BSS Sounding with in-BSS for Responder Only |
| 10-15 | Reserved |

In an embodiment, additionally or alternatively, the CoBF sounding type information (e.g., a CoBF sounding type field) may be included in the NDPA sent by the initiating AP to the responding AP. The responding AP may prepare for the sequence of CoBF sounding according to the variant of the CoBF sounding as indicated by the CoBF sounding type information or field.

According to an embodiment, the initiating AP in CoBF sounding may send the CoBF sounding invite frame with the CoBF Sounding Type field set to one of the values listed in Table 8 to indicate the type of CoBF sounding the invite is initiating.

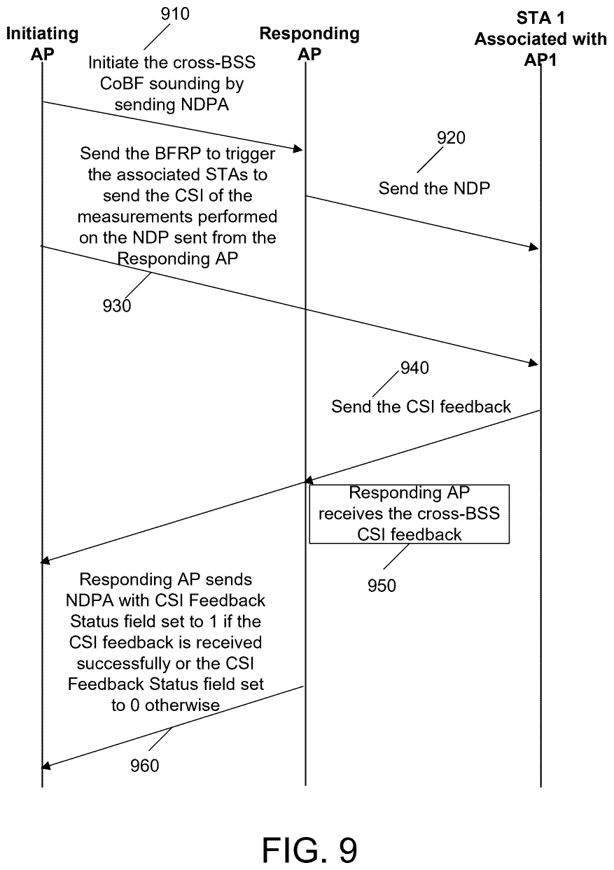

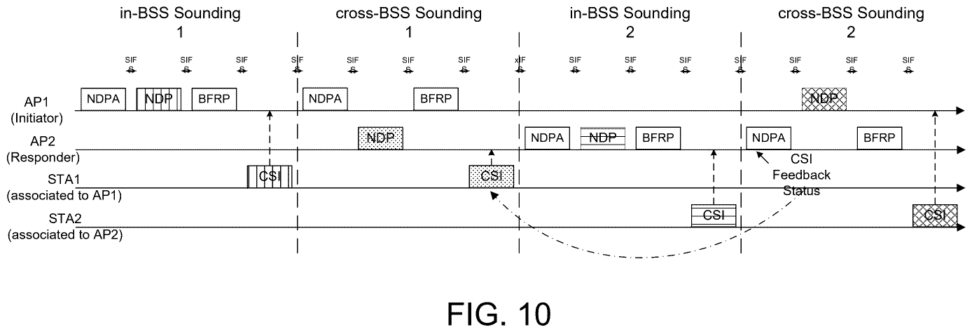

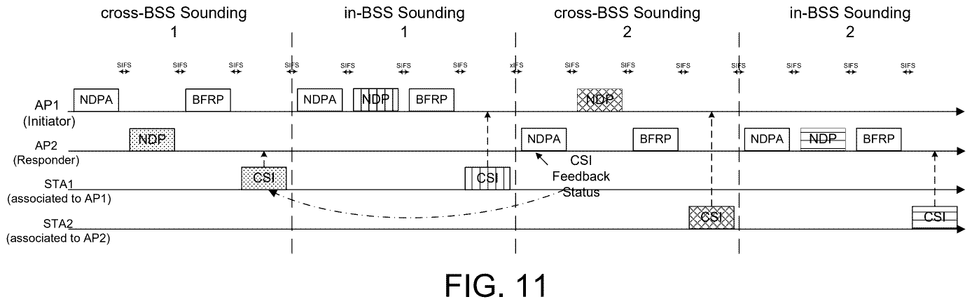

FIG. 9 illustrates an example message flow diagram depicting a procedure for a responding AP to indicate the status of receiving CSI feedback, according to some embodiments. As illustrated in the example of FIG. 9, at 910, a cross-BSS sounding sequence may include, at 910, the Initiating AP (e.g., AP1) sending a NDPA. For example, (e.g., after a SIFS) based on receiving the NDPA, the Responding AP (e.g., AP2) may transmit the NDP at 920. The initiating AP (e.g., after a SIFS) may send, at 930, a BFRP trigger frame to trigger the associated STAs (e.g., STA1) to send the CSI of the measurements performed on the NDP sent from the Responding AP. At 940, STA1 may send CSI (e.g., cross-BSS CSI feedback). The responding AP may, at 950, receive the CSI (e.g., cross-BSS CSI feedback), decode it (or attempt to decode it) and evaluate whether it is received successfully or not (e.g., the CSI may be considered to have been received successfully if the AP can decode, read and/or otherwise access the measurement(s) indicated in the CSI). The Responding AP may (e.g., after an xIFS, such as a SIFS or any Inter Frame Space) send, at 960, the NDPA to start its part of the CoBF sequential sounding (e.g., cross-BSS Sounding 2 as illustrated in FIGS. 10 and 11 discussed below). In certain embodiments, the Responding AP may set the field CSI Feedback Status in the NDPA to 1 if the CSI feedback is received successfully or set the field CSI Feedback Status in the NDPA to 0 otherwise (e.g., see Table 5).

FIG. 10 illustrates an example diagram of the sequences (e.g., in-BSS and cross-BSS sounding sequences) associated with CoBF sounding, according to some embodiments. As illustrated in the example of FIG. 10, in-BSS sounding 1 may include AP1 (e.g., initiating AP in this example) sending a first NDPA, followed (e.g., after a SIFS) by a first NDP and first BFRP trigger frame. STAs associated with AP1 (e.g., STA1 in the example of FIG. 10) may then respond (e.g., after a SIFS) with a first CSI (e.g., a beamforming feedback report). As further shown in the example of FIG. 10, cross-BSS sounding 1 may include AP1 sending a second NDPA, and AP2 sending a second NDP (e.g., after a SIFS) that may be received by STAs associated with AP1 (e.g., STA1). AP1 may then (e.g., after a SIFS) send a second BFRP trigger frame. Based on the NDP, the STAs associated with AP1 (e.g., STA1) may send a second CSI (e.g., a beamforming feedback report) that is overheard (e.g., received) by AP2. For example, in one embodiment, AP2 may receive the CSI (e.g., cross-BSS CSI feedback), decode it (or attempt to decode it) and determine whether the CSI is received successfully or not (e.g., the CSI may be considered to have been received successfully if the AP can decode, read and/or otherwise access the measurement(s) indicated in the CSI).

In certain embodiments, the in-BSS sounding and cross-BSS sounding sequences may be repeated (e.g., after a SIFS) but with AP2 taking the lead by transmitting a third NDPA. For example, as illustrated in the example of FIG. 10, in-BSS sounding 2 may include AP2 sending a third NDPA, e.g., to its associated STA(s) including the STA(s) that are participating in this CoBF sounding session (e.g., STA2). According to one embodiment, the third NDPA transmitted by AP2 may optionally include or indicate CSI feedback status information (e.g., a CSI feedback status field discussed above) to indicate whether the CSI transmitted by STA1 during cross-BSS sounding 1 was successfully received by AP2 (e.g., whether AP2 successfully received, decoded, read and/or otherwise accessed the measurement(s) indicated in the CSI). This indication in the third NDPA may alternatively be included in the fourth NDPA, as discussed below. Then, (e.g., after a SIFS) AP2 may send a third NDP followed (e.g., after a SIFS) by a BFRP trigger frame. STAs associated with AP2 (e.g., STA2) may respond (e.g., after a SIFS) with a third CSI (e.g., beamforming feedback report).

As further illustrated in the example of FIG. 10, AP2 may send a fourth NPDA, e.g., to its associated STA(s) including the STA(s) that are participating in this CoBF sounding session (e.g., STA2). According to an embodiment, the fourth NDPA transmitted by AP2 may include or indicate CSI feedback status information (e.g., a CSI feedback status field discussed above) to indicate whether the CSI transmitted by STA1 during cross-BSS sounding 1 was successfully received by AP2 (e.g., whether AP2 successfully received, decoded, read and/or otherwise accessed the measurement(s) indicated in the CSI). AP1 may transmit (e.g., after a SIFS) an NDP, which may be received by the STAs associated with AP2 that are participating in this CoBF sounding session (e.g., STA2). AP2 may send (e.g., after a SIFS) a BFRP trigger frame that may be followed by a fourth CSI (e.g., beamforming feedback report) sent from STA2 and overheard (e.g., received) by AP1.

It is noted that the sequence of operation in CoBF sequential sounding (i.e., in-BSS sounding and cross-BSS sounding) may be reordered such that cross-BSS sounding is performed before in-BSS sounding. Also, the sequence of operation may be reordered such that AP2 performs its part of the CoBF sounding (e.g., in-BSS and/or cross-BSS sounding) before AP1. For example, FIG. 11 illustrates a diagram similar to that of FIG. 10, but in which the cross-BSS sounding is performed before in-BSS sounding and the CSI feedback status information associated with the receipt of the CSI transmitted in the first cross-BSS sounding is indicated in the NDPA sent by AP2 during the second cross-BSS sounding sequence.

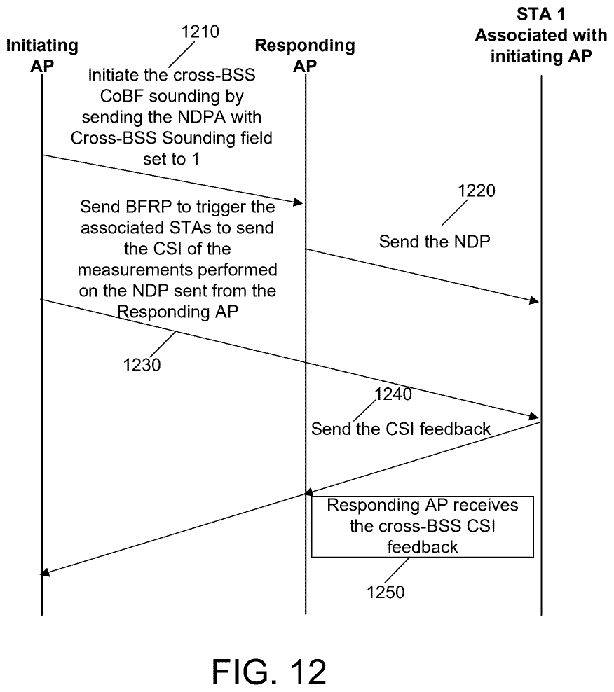

According to certain embodiments, an AP may indicate to initiate cross-BSS sounding. FIG. 12 illustrates a message flow diagram depicting the initiation of a cross-BSS sounding sequence, according to an embodiment. As illustrated in the example of FIG. 12, at 1210, the initiating AP (e.g., AP1) may start a cross-BSS sounding sequence by sending an NDPA with an indication set to a certain value, e.g., with a cross-BSS sounding field set to 1 (e.g., see Table 6). The responding AP (e.g., after a SIFS) may, at 1220, transmit a NDP (e.g., responsive to receiving the NDPA). Then, the initiating AP (e.g., after a SIFS) may send, at 1230, the BFRP trigger frame to trigger the associated STAs (e.g., STA1) to send the CSI associated with the measurements performed on the NDP sent from the responding AP. At 1240, the STA associated with initiating AP (e.g., STA1) may send the CSI. At 1250, the responding AP may then receive the CSI (e.g., cross-BSS CSI feedback), decode it (or attempt to decode it) and/or evaluate whether it the CSI received successfully or not.

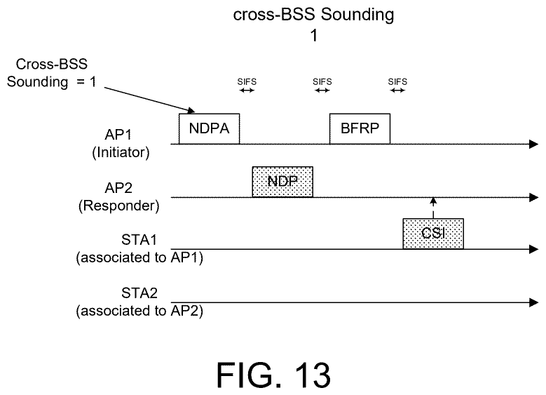

FIG. 13 illustrates an example diagram for initiating a cross-BSS sounding sequence (e.g., initiating only the cross-BSS sounding sequence by the initiating AP), according to certain embodiments. For example, as discussed above with respect to FIG. 12, a cross-BSS sounding sequence can be initiated by using information or a field in a NDPA. As depicted in the example of FIG. 13, the initiating AP (e.g., AP1) may send a NDPA including or indicating that just cross-BSS sounding should be initiated or performed. For example, the initiating AP may set a cross-BSS sounding field of the NDPA to a value, such as 1, to indicate or request that only cross-BSS sounding sequence be initiated. The responding AP (e.g., after a SIFS) may transmit a NDP, and the initiating AP (e.g., after a SIFS) may send the BFRP trigger frame to trigger the associated STAs (e.g., STA1) to send the CSI associated with the measurements performed on the NDP sent from the responding AP. The responding AP may then receive the CSI (e.g., cross-BSS CSI feedback), decode it (or attempt to decode it) and/or evaluate whether the CSI is received successfully or not.

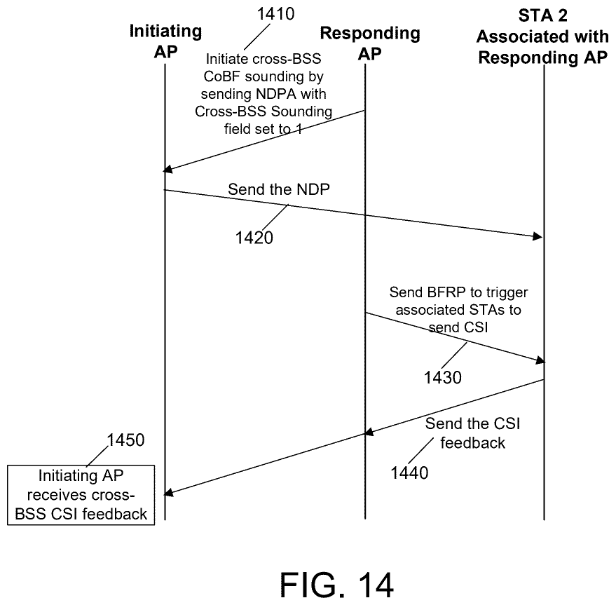

FIG. 14 illustrates an example message flow diagram depicting a responding AP (e.g., AP2) initiating a cross-BSS sounding sequence (e.g., initiating only the cross-BSS sounding sequence and not the in-BSS sounding sequence), according to some embodiments. In the example of FIG. 14, at 1410, responding AP (e.g., AP2) sends an NDPA with a cross-BSS sounding field set to 1 (e.g., see Table 6). At 1420, the initiating AP (e.g., after a SIFS) may transmit the NDP (e.g., responsive to the NDPA). Then, the responding AP (e.g., after a SIFS) may send, at 1430, the BFRP trigger frame to trigger the associated STAs (e.g., STA2) to send a CSI (e.g., a CSI of measurements performed on the NDP). At 1440, the STA may send the CSI. For example, the CSI may be a CSI that includes or is based on the measurements performed on the NDP sent from the initiating AP. The initiating AP may receive, at 1450, the CSI (e.g., cross-BSS CSI feedback), decode or attempt to decode it, and/or evaluate whether it is received successfully or not, as discussed elsewhere herein.

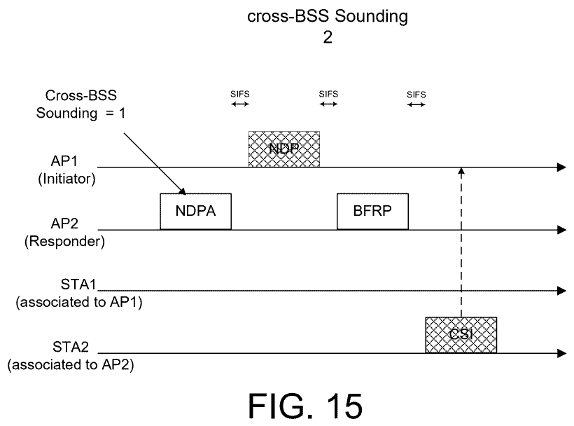

FIG. 15 illustrates an example diagram for initiating a cross-BSS sounding sequence (e.g., initiating only the cross-BSS sounding sequence by a responding AP), according to certain embodiments. For example, as discussed above with respect to FIG. 14, a cross-BSS sounding sequence can be initiated by using information or a field in a NDPA. As depicted in the example of FIG. 15, the responding AP (e.g., AP2) may send a NDPA including or indicating that just cross-BSS sounding should be initiated or performed. For example, the responding AP may set a cross-BSS sounding field of the NDPA to a value, such as 1, to indicate or request that only cross-BSS sounding sequence be initiated. The initiating AP (e.g., after a SIFS) may transmit the NDP (e.g., responsive to the NDPA). Then, the responding AP (e.g., after a SIFS) may send the BFRP trigger frame to trigger the associated STAs (e.g., STA2) to send a CSI (e.g., a CSI of measurements performed on the NDP). For example, the CSI may be a CSI that includes or is based on the measurements performed on the NDP sent from the initiating AP. The initiating AP may receive the CSI (e.g., cross-BSS CSI feedback), decode or attempt to decode it, and/or evaluate whether it is received successfully or not, as discussed elsewhere herein.

Table 9 illustrates examples of the different options for the initiating AP (e.g., AP1) and responding AP (e.g., AP2) behavior in different scenarios with respect to the CSI feedback status and being the TXOP holder in the CoBF data transmission phase, according to certain embodiments. In the example of Table 9, Cross-CSI 1 refers to the CSI feedback status of receiving the CSI feedback in the cross-BSS Sounding 1 as illustrated in FIG. 10 or FIG. 11. Also, Cross-CSI 2 refers to the CSI feedback status of receiving the CSI feedback in the cross-BSS Sounding 2 as illustrated in FIG. 10 or FIG. 11.

TABLE 9
Initiating and Responding AP Behavior Under Different Scenarios Regarding
CSI Feedback Status and Being TXOP Holder in CoBF Data Transmission Phase

| | | AP1 is | AP2 is | |
|---|---|---|---|---|
| | | TXOP | TXOP | |
| | | Holder in | Holder in | |
| Cross- | Cross- | the | the | |
| CSI 1 | CSI 2 | Transmission | Transmission | |
| Successful | Successful | Phase | Phase | Behavior |
| 1 | 1 | Yes | No | Option1: |
| | | | | 1) AP1 sends the Invite frame. |
| | | | | 2) If AP2 responds with a Response frame with |
| | | | | status Accept, AP1 sends the Sync trigger frame to |
| | | | | complete the CoBF transmission |
| | | | | 3) If AP2 responds with a Response frame with |
| | | | | status Reject, AP2 indicates a reason for rejection |
| | | | | from Table 7 and AP1 may proceed by |
| | | | | transmitting one or more PPDUs to its associated |
| | | | | STAs |
| 1 | 1 | No | Yes | Option1: |
| | | | | 1) AP2 sends the CoBF Invite frame. |
| | | | | 2) If AP1 responds with a CoBF Response frame |
| | | | | with status Accept, AP2 sends the Sync trigger |
| | | | | frame to complete the CoBF transmission |
| | | | | 3) If AP1 responds with a CoBF Response frame |
| | | | | with status Reject, AP1 indicates a reason for |
| | | | | rejection from Table 7 and AP2 may proceed by |
| | | | | transmitting one or more PPDUs to its associated |
| | | | | STAs |
| | | | | Option2: AP2 enquires AP1 about CSI Feedback |
| | | | | Status before sending CoBF Invite with a short |
| | | | | frame exchange sequence |
| | | | | Option3: AP2 avoids sending the CoBF Invite |
| | | | | frame and refrains from initiating the CoBF |
| | | | | transmission |
| 1 | 0 | Yes | No | Option1: |
| | | | | 1) AP1 sends CoBF Invite frame to AP2 with the |
| | | | | CSI Feedback Status in the CoBF Invite frame is |
| | | | | set to a value to indicate that cross-BSS2 is not |
| | | | | received successfully |
| | | | | 2) AP2 shall respond with a CoBF Response with |
| | | | | status Reject and indicates a reason for rejection |
| | | | | from Table 7 |
| | | | | 3) After a period of time, AP2 sends NDPA with a |
| | | | | field (Cross BSS Sounding) to indicate that this is |
| | | | | to initiate a repetition for cross-BSS2 sounding |
| | | | | only |
| | | | | Option2: AP1 enquires AP2 about CSI Feedback |
| | | | | Status before sending CoBF Invite with a short |
| | | | | frame exchange sequence |
| | | | | Option3: AP1 avoids sending the CoBF Invite |
| | | | | frame and refrains from initiating the CoBF |
| | | | | transmission |
| 1 | 0 | No | Yes | Option1: |
| | | | | 1) AP2 sends the CoBF Invite frame. |
| | | | | 2) If AP1 responds with a CoBF Response frame |
| | | | | with status Accept, AP2 sends the Sync trigger |
| | | | | frame to complete the CoBF transmission |
| | | | | 3) If AP1 responds with a CoBF Response frame |
| | | | | with status Reject, AP1 indicates a reason for |
| | | | | rejection from Table 7 and AP2 may proceed by |
| | | | | transmitting one or more PPDUs to its associated |
| | | | | STAs |
| | | | | Option2: AP2 enquire AP1 about CSI Feedback |
| | | | | Status before sending a CoBF Invite with a short |
| | | | | frame exchange sequence |
| | | | | Option3: AP2 avoids sending the CoBF Invite |
| | | | | frame and refrains from initiating the CoBF |
| | | | | transmission |
| 0 | 1 | Yes | No | Option1: AP1 sends NDPA with a field (Cross |
| | | | | BSS Sounding) to indicate that this is a repetition |
| | | | | for cross-BSS1 sounding only |
| | | | | Option2: AP1 avoids sending the CoBF Invite |
| | | | | frame and refrains from initiating the CoBF |
| | | | | transmission |
| 0 | 1 | No | Yes | Option1: AP2 avoids sending the CoBF Invite |
| | | | | frame and refrains from initiating the CoBF |
| | | | | transmission |
| 0 | 0 | Yes | No | Option1: |
| | | | | 1) AP1 sends NDPA with a field (Cross BSS |
| | | | | Sounding) to indicate that this is a repetition for |
| | | | | cross-BSS1 sounding only |
| | | | | 2) After a period of time, AP1 sends the CoBF |
| | | | | Invite frame. |
| | | | | 3) If AP2 responds with a Response frame with |
| | | | | status Reject and indicates a reason for rejection |
| | | | | from Table 7 as Failed to Receive Cross-BSS CSI, |
| | | | | then later AP1 sends NDPA with a field (Cross |
| | | | | BSS Sounding) to indicate that this is to initiate a |
| | | | | repetition for cross-BSS1 sounding only |
| | | | | Option2: |
| | | | | 1) AP1 sends NDPA with a field (Cross BSS |
| | | | | Sounding) to indicate that this is a repetition for |
| | | | | cross-BSS1 only and use the CSI Feedback Status |
| | | | | field to indicate that AP1 did not receive cross- |
| | | | | BSS2. |
| | | | | 2) Then, AP2 sends NDPA with a field (Cross |
| | | | | BSS Sounding) to indicate that this is a repetition |
| | | | | for cross-BSS2 only |
| | | | | Option3: AP1 avoids sending the CoBF Invite |
| | | | | frame and refrains from initiating the CoBF |
| | | | | transmission |
| 0 | 0 | No | Yes | Option1: |
| | | | | 1) AP2 sends NDPA with a field (Cross BSS |
| | | | | Sounding) to indicate that this is a repetition for |
| | | | | cross-BSS1 sounding only |
| | | | | 2) After a period of time, AP2 sends the CoBF |
| | | | | Invite frame. |
| | | | | 3) If AP1 responds with a Response frame with |
| | | | | status Reject and indicates a reason for rejection |
| | | | | from Table 7 as Failed to Receive Cross-BSS CSI, |
| | | | | then later AP2 sends NDPA with a field (Cross |
| | | | | BSS Sounding) to indicate that this is to initiate a |
| | | | | repetition for cross-BSS2 sounding only |
| | | | | Option2: |
| | | | | 1) AP2 sends NDPA with a field (Cross BSS |
| | | | | Sounding) to indicate that this is a repetition for |
| | | | | cross-BSS2 only and use the CSI Feedback Status |
| | | | | field to indicate that AP2 did not receive cross- |
| | | | | BSS1. |
| | | | | 2) Then, AP1 sends NDPA with a field (Cross |
| | | | | BSS Sounding) to indicate that this is a repetition |
| | | | | for cross-BSS1 only |
| | | | | Option3: AP2 avoids sending the Invite frame and |
| | | | | refrains from initiating the CoBF transmission |

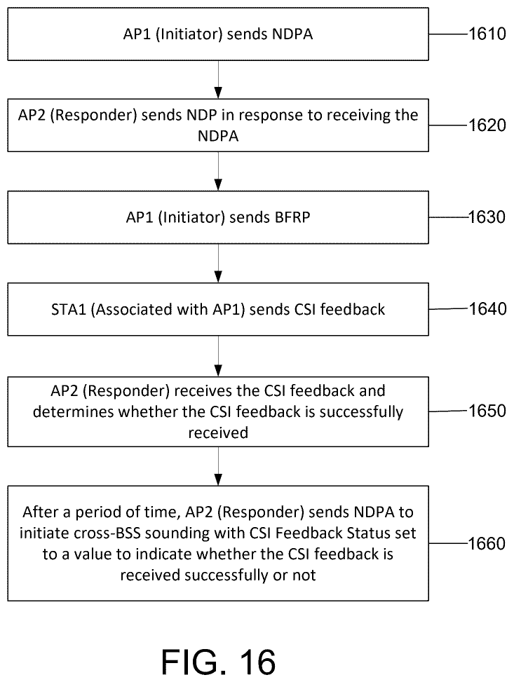

FIG. 16 illustrates an example flow diagram of a method for CoBF sounding, according to some embodiments. For instance, FIG. 16 illustrates an example of how a responding AP can indicate the status associated with receiving CSI feedback in sequential CoBF sounding. As depicted in the example of FIG. 16, at 1610, the initiating AP (e.g., AP1) may send a NDPA. At 1620, the responding AP may transmit a NDP (e.g., in response to receiving the NDPA). At 1630, the initiating AP may send the BFRP trigger frame to trigger the associated STAs (e.g., STA1) to send CSI. At 1640, the STA associated with initiating AP (e.g., AP1) may send the CSI associated with the measurements performed on the NDP sent from the responding AP. At 1650, the responding AP may receive the CSI (e.g., cross-BSS CSI feedback), decode it (or attempt to decode it) and/or determine whether the CSI is received successfully or not. After a period of time, at 1660, the responding AP may send a NDPA to initiate cross-BSS sounding. The NDPA sent by the responding AP may include a CSI feedback status set to a value to indicate whether the CSI was received successfully or not.

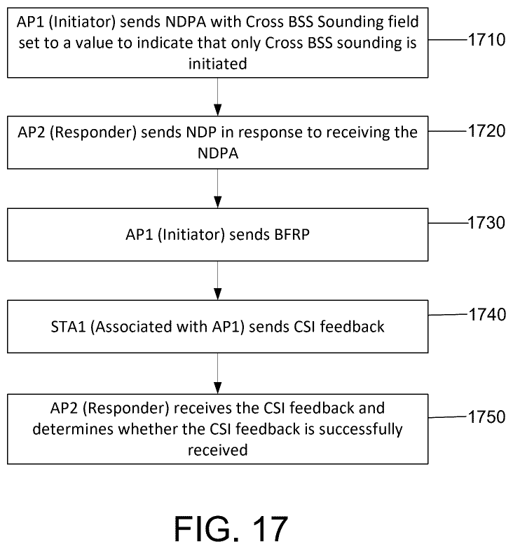

FIG. 17 illustrates an example flow diagram of a method for CoBF sounding, according to some embodiments. For instance, FIG. 17 illustrates an example of how an initiating AP can initiate a cross-BSS sounding sequence (e.g., initiate only a cross-BSS sounding sequence). As depicted in the example of FIG. 17, at 1710, the initiating AP may send a NDP. The NDPA may include cross-BSS sounding field set to a value to indicate or request that cross-BSS sounding is to be initiated (e.g., only cross-BSS sounding is to be initiated). At 1720, the responding AP may send a NDP (e.g., responsive to receiving the NDPA). At 1730, the initiating AP may send a BFRP trigger frame (e.g., to trigger the associated STAs (e.g., STA1) to send CSI). At 1740, the STA associated with the initiating AP (e.g., STA1) may send the CSI. At 1750, the responding AP may receive the CSI, decode it (or attempt to decode it) and/or determine whether the CSI is received successfully or not.

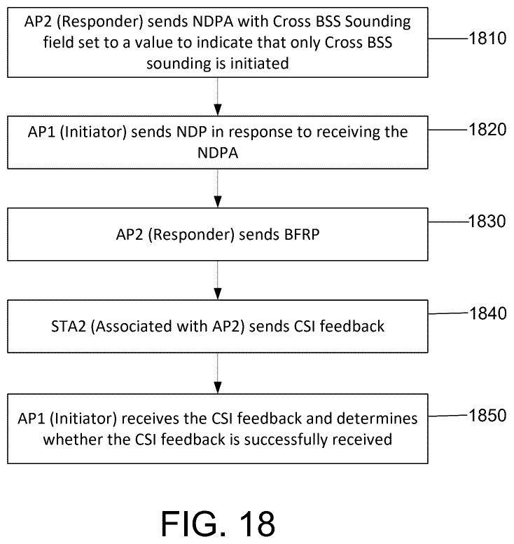

FIG. 18 illustrates an example flow diagram of a method for CoBF sounding, according to some embodiments. For instance, FIG. 18 illustrates an example of how a responding AP can initiate a cross-BSS sounding sequence (e.g., initiate only a cross-BSS sounding sequence). As depicted in the example of FIG. 18, at 1810, the responding AP may send a NDPA. For example, the NDPA may include a cross-BSS sounding field set to a value to indicate that cross-BSS sounding is to be initiated (e.g., only cross-BSS sounding is to be initiated). At 1820, the initiating AP may send a NDP (e.g., responsive to receiving the NDPA). At 1830, the responding AP may send a BFRP trigger frame (e.g., to trigger its associated STAs (e.g., STA2) to send CSI). At 1840, the STA associated with the responding AP (e.g., STA2) may send the CSI. At 1850, the initiating AP may receive the CSI, decode it (or attempt to decode it) and/or determine whether the CSI is received successfully or not, as discussed elsewhere herein.

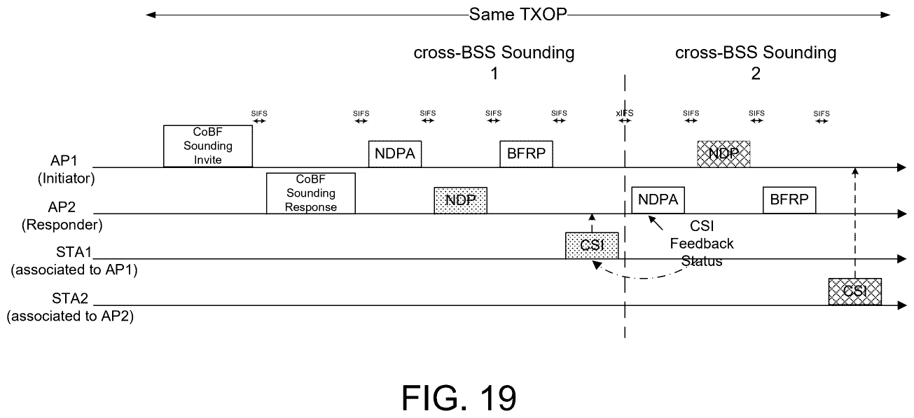

Certain embodiments may relate to cross-BSS sounding sessions in the same TXOP or different TXOPs. FIG. 19 illustrates an example diagram of cross-BSS sounding sessions in the same TXOP (e.g., two cross-BSS sounding sequences taking place in the same TXOP), according to an embodiment. As illustrated in the example of FIG. 19, the initiating AP may send the CoBF Sounding Invite frame to the responding AP to initiate a CoBF sounding sequence which may include the cross-BSS sounding for both the initiating AP and the responding AP in the same TXOP. In an embodiment, additionally or alternatively, the initiating AP may send the CoBF Sounding Invite frame to the responding AP with the CoBF Sounding Type field set to a value (such as 5 in Table 8) to indicate that the invitation is for sequential sounding where cross-BSS sounding (e.g., only cross-BSS sounding) is performed for both the initiating AP and the responding AP in the same TXOP. In an embodiment, additionally or alternatively, the initiating AP may send the first NDPA to the responding AP with the CoBF Sounding Type field set to a value (such as 5 in Table 8) to indicate that the invitation is for sequential sounding where cross-BSS sounding (e.g., only cross-BSS sounding) is performed for both the initiating AP and the responding AP in the same TXOP.

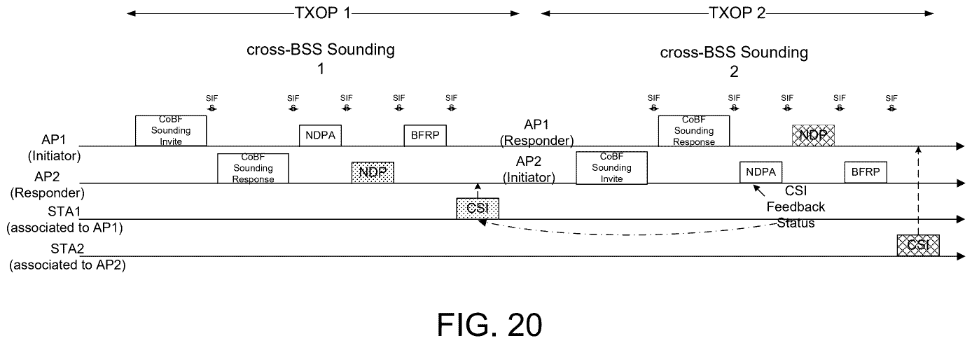

FIG. 20 illustrates an example diagram of cross-BSS sounding sessions in different TXOPs (e.g., two cross-BSS sounding sequences taking place in two different TXOPs with two separate sounding invite/response exchanges), according to an embodiment. As illustrated in the example of FIG. 20, the initiating AP may send the CoBF Sounding Invite frame to the responding AP to initiate a CoBF sounding sequence which may include the cross-BSS sounding for the initiating AP only. In this scenario, the cross-BSS sounding for each AP participating in the CoBF transmission may happen in a different TXOP. Each AP may initiate its cross-BSS sounding by sending a CoBF Sounding Invite to the other AP. In an embodiment, additionally or alternatively, the initiating AP may send the CoBF Sounding Invite frame to the responding AP with the CoBF Sounding Type field set to a value (such as 6 in Table 8) to indicate that the invitation is for sequential sounding where cross-BSS sounding (e.g., only cross-BSS sounding) is performed for the initiating AP. In an embodiment, additionally or alternatively, the initiating AP may send the first NDPA to the responding AP with the CoBF Sounding Type field set to a value (such as 6 in Table 8) to indicate that the invitation is for sequential sounding where cross-BSS sounding (e.g., only cross-BSS sounding) is performed for the initiating AP. It is noted that, in the first TXOP (TXOP 1), AP1 in the initiating AP and AP2 in the responding AP, while in the second TXOP (TXOP 2), AP2 is the initiating AP and AP1 is the responding AP.

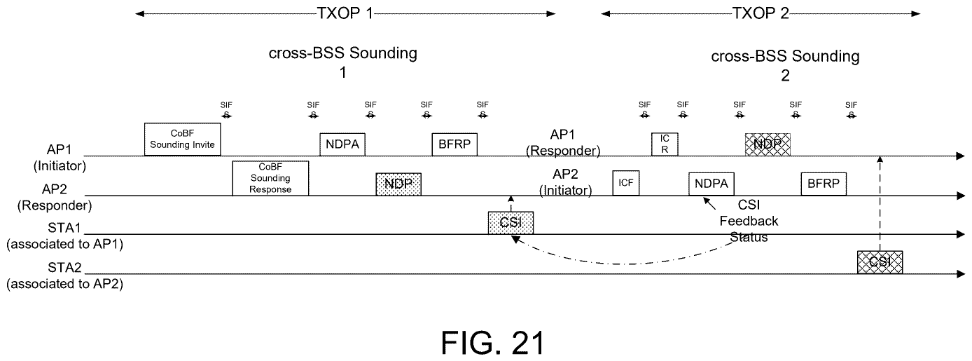

FIG. 21 illustrates an example diagram of cross-BSS sounding sessions in different TXOPs (e.g., two cross-BSS sounding sessions taking place in two different TXOPs with ICF/ICR exchange for the second cross-BSS sounding), according to an embodiment. As illustrated in the example of FIG. 21, the initiating AP (AP1) in the first TXOP may send the CoBF Sounding Invite frame to the responding AP to initiate a CoBF sounding sequence which may include the cross-BSS sounding for the initiating AP only. Later, in another TXOP, the initiating AP (AP2) may send an ICF to the responding AP (AP1) and the responding AP may then respond with an ICR. In an embodiment, additionally or alternatively, the initiating AP may send the CoBF Sounding Invite frame to the responding AP with the CoBF Sounding Type field set to a value (such as 6 in Table 8) to indicate that the invitation is for sequential sounding where cross-BSS sounding (e.g., only cross-BSS sounding) is performed for the initiating AP in this TXOP and, in a another TXOP acquired by the responding AP, the responding AP may send an ICF to the initiating AP which in turn may respond with an ICR to complete a cross-BSS sounding sequence for the responding AP. It is noted that the difference between the frame exchange sequence in the example of FIG. 21 and the frame exchange sequence in the example of FIG. 20 is that, in the second TXOP, the initiating AP sends ICF instead of a CoBF Sounding Invite frame and the responding AP responds with an ICR instead of a CoBF Response frame.

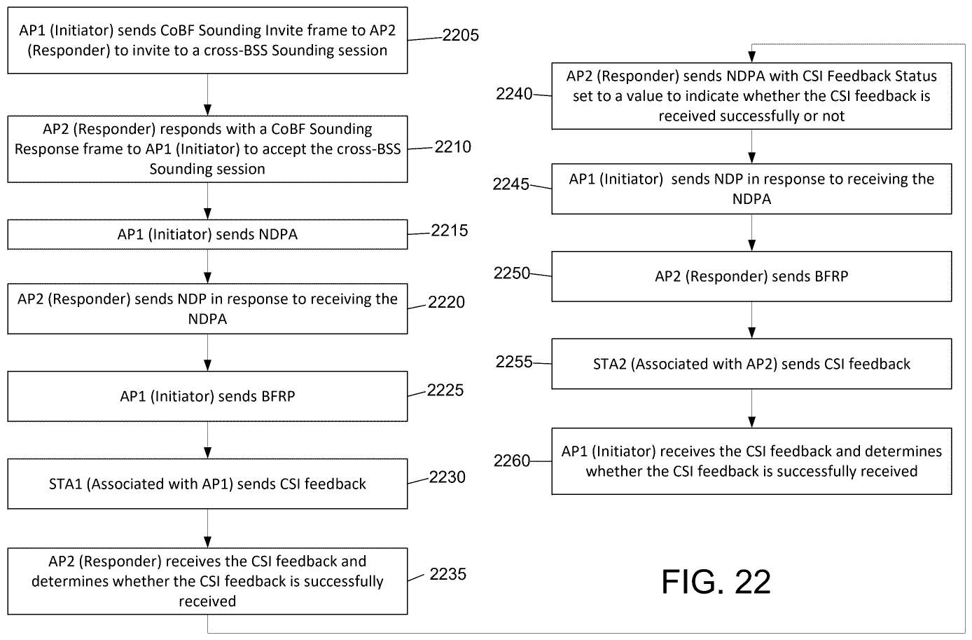

FIG. 22 illustrates an example flow diagram of a method for performing cross-BSS sounding sequences in the same TXOP, according to some embodiments. As illustrated in the example of FIG. 22, at 2205, the initiating AP may send a CoBF sounding invite frame to the responding AP to invite it to a cross-BSS sounding session. At 2210, the responding AP may send a CoBF sounding response frame to the initiating AP to accept the cross-BSS sounding session. At 2215, the initiating AP may send a NDPA. At 2220, the responding AP may send a NDP (e.g., responsive to receiving the NDPA). At 2225, the initiating AP may send a BFRP trigger frame (e.g., to trigger CSI feedback from the STA associated with the initiating AP). At 2230, the STA associated with the initiating AP may send CSI. At 2235, the responding AP may receive the CSI, decode or attempt to decode it, and/or determine whether the CSI was received successfully. At 2240, the responding AP may send a NDPA. For example, the NDPA may include an indication of CSI feedback status that is set to a value to indicate whether the CSI feedback is received successfully or not. At 2245, the initiating AP may send NDP (e.g., responsive to receiving the NDPA). At 2250, the responding AP may send BFRP trigger frame (e.g., to trigger CSI feedback from the STA associated with the responding AP). At 2255, the STA associated with the responding AP may send the CSI. At 2260, the initiating AP may receive the CSI, decode or attempt to decode it, and/or determine whether the CSI was received successfully.

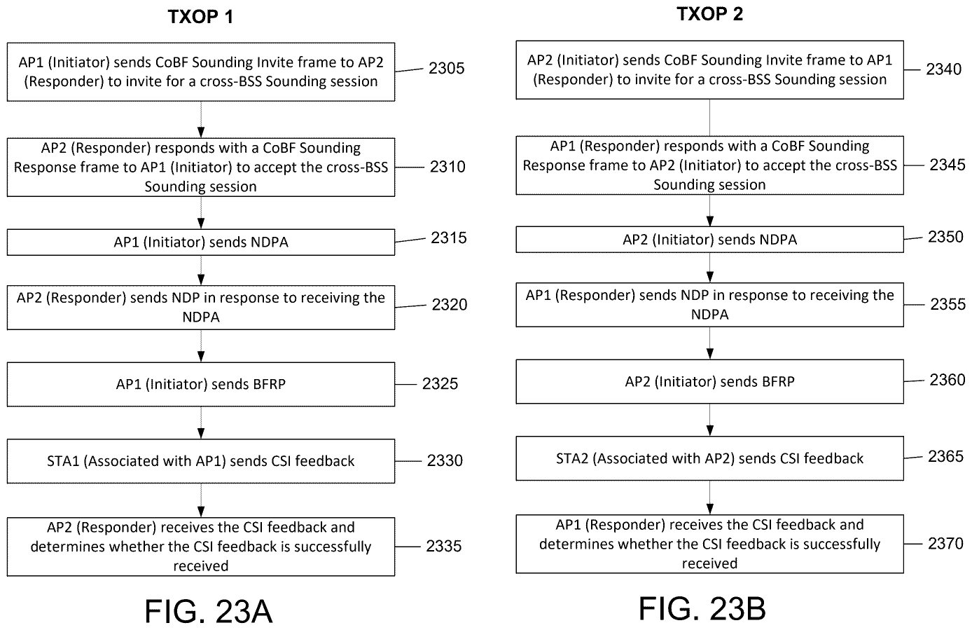

FIGS. 23A and 23B illustrate example flow diagrams of a method for performing cross-BSS sounding sequences in the two different TXOPs, according to some embodiments. In particular, FIG. 23A illustrates a method in the first TXOP (TXOP 1) and FIG. 23B illustrates a method in the second TXOP (TXOP 2).

As illustrated in the example of FIG. 23A, at 2305, the initiating AP (e.g., AP1 in this example) may send CoBF Sounding Invite frame to responding AP (e.g., AP2 in this example) to invite it to a cross-BSS sounding session. At 2310, the responding AP may send a CoBF Sounding Response frame to the initiating AP to accept the cross-BSS sounding session. At 2315, the initiating AP may send a NDPA. At 2320, the responding AP may send NDP (e.g., responsive to the NDPA). At 2325, the initiating AP may send a BFRP trigger frame (e.g., to trigger the STA1 associated with the initiating AP to send CSI). At 2330, the STA associated with the initiating AP (e.g., STA1) may send CSI. At 2335, the responding AP may receive the CSI, decode or attempt to decode it, and/or determine whether the CSI was received successfully.

The example of FIG. 23B is similar to that of FIG. 23A, except that the initiating AP and responding AP are switched, i.e., the initiating AP is now AP2 and the responding AP is now AP1. As illustrated in the example of FIG. 23B, at 2340, the initiating AP (e.g., AP2 in this example) may send CoBF Sounding Invite frame to responding AP (e.g., AP1 in this example) to invite it to a cross-BSS sounding session. At 2345, the responding AP may send a CoBF Sounding Response frame to the initiating AP to accept the cross-BSS sounding session. At 2350, the initiating AP may send a NDPA. At 2355, the responding AP may send NDP (e.g., responsive to the NDPA). At 2360, the initiating AP may send a BFRP trigger frame (e.g., to trigger the STA2 associated with the initiating AP2 to send CSI). At 2365, the STA associated with the initiating AP (e.g., STA2) may send CSI. At 2370, the responding AP may receive the CSI, decode or attempt to decode it, and/or determine whether the CSI was received successfully.

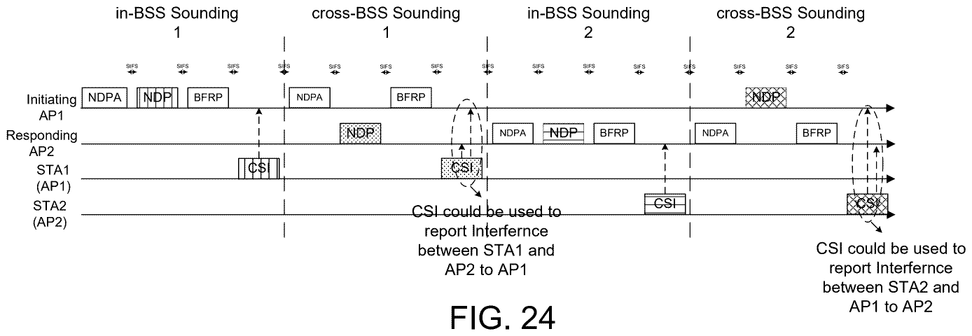

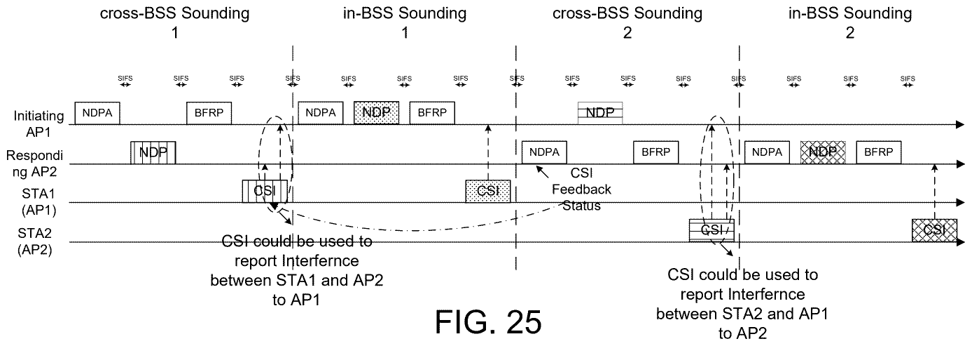

Certain embodiments may use cross-BSS sounding measurements for CoSR. FIG. 24 illustrates an example CoBF sequential sounding sequence in which the in-BSS sounding sequence comes first and the cross CSI is used to report interference between STAs and the OBSS, according to some embodiments. FIG. 25 illustrates an example CoBF sequential sounding sequence in which the cross-BSS sounding sequence comes first and the cross CSI is used to report interference between STAs and the OBSS, according to some embodiments. As illustrated in the examples of FIGS. 24 and 25, the cross-BSS CSI 1 triggered by initiating AP1, sent by STA1 and received by responding AP2 may be also received by AP1. AP1 may use the CSI to extract measurements for the interference between STA1 and AP2 which may be used to make decisions related to CoSR transmission between AP1 and AP2. Similarly, in an embodiment, the cross-BSS CSI 2 triggered by AP2, sent by STA2 and received by AP1 may be also received by AP2. AP2 may use the CSI to extract measurements for the interference between STA2 and AP1 which may be used to make decisions related to Co—SR transmission between AP1 and AP2. Further, the same behaviour may be applied in cases where only cross-BSS sounding is performed by AP1 and AP2 in the same TXOP, or by AP1 only in one TXOP, or by AP2 only in another TXOP.

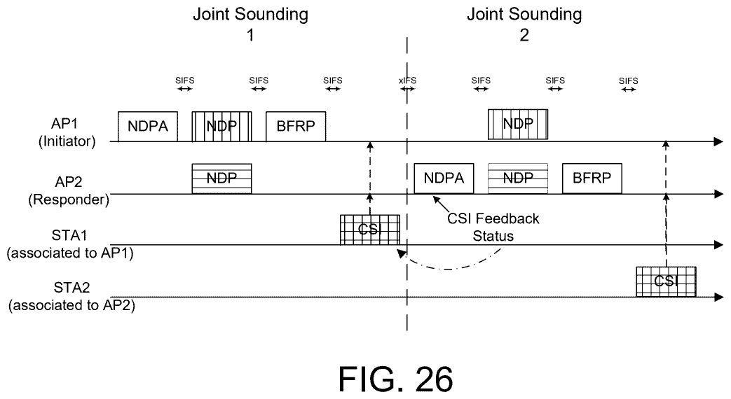

Certain embodiments may relate to CoBF joint sounding. The behavior of the APs defined for CoBF joint sounding is discussed in the following. FIG. 26 illustrates an example CoBF joint sounding sequence with a CSI feedback status field included in the NDPA of AP2, according to some embodiments. As illustrated in the example of FIG. 26, initiating AP1 may start the sounding sequence by sending a NDPA which includes its associated STAs that are participating in this CoBF sounding session (e.g., STA1) and to the STAs associated with AP2 that are participating in this CoBF sounding session (e.g., STA2). Then, AP1 and AP2 may jointly send (e.g., after a SIFS) an NDP over different spatial streams that are allocated in the NDPA. AP1 may send (e.g., after a SIFS) a BFRP trigger frame. STAs associated with AP1 that are participating in this CoBF sounding session (e.g., STA1) may respond with CSI (e.g., a beamforming feedback report). This CSI feedback is received by both AP1 and AP2. Then, AP2 may send a NDPA which includes its associated STAs that are participating in this CoBF sounding session (e.g., STA2) and to the STAs associated with AP1 that are participating in this CoBF sounding session (e.g., STA1). Then, AP1 and AP2 may jointly send (e.g., after a SIFS) a NDP over different spatial streams that are allocated in the NDPA. AP2 may send a BFRP trigger frame. STAs associated with AP2 that are participating in this CoBF sounding session (e.g., STA2) may respond (e.g., after a SIFS) with CSI (e.g., a beamforming feedback report). This CSI feedback is received by both AP1 and AP2. In one embodiment, the Responding AP (AP2) may set a CSI feedback status field in the NDPA it transmits to 1 if the CSI feedback is received successfully or set the CSI feedback status field in the NDPA to 0 otherwise (e.g., see Table 5).

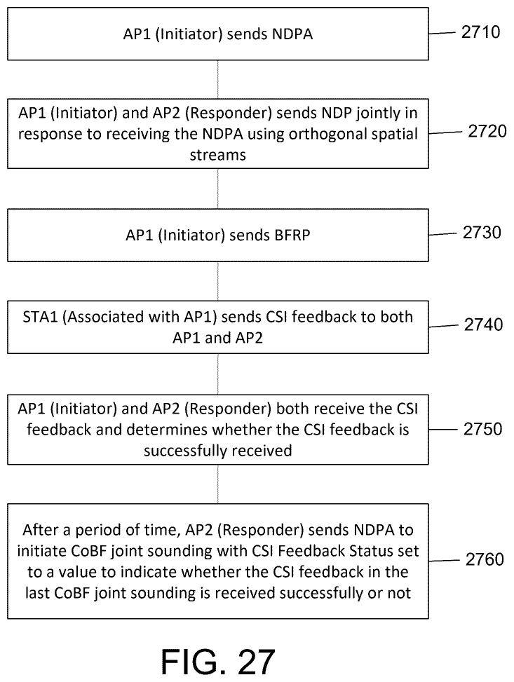

FIG. 27 illustrates a flow diagram of a method for CoBF joint sounding, according to some embodiments. As illustrated in the example of FIG. 27, at 2710, the initiating AP may send a NDPA. At 2720, the initiating AP and responding AP may send NDP jointly in response to receiving the NDPA using orthogonal spatial streams. At 2730, the initiating AP may send a BFRP trigger frame. At 2740, the STA associated with the initiating AP may send CSI to both the initiating AP and the responding AP. At 2750, the initiating AP and the responding AP may both receive the CSI feedback and may determine whether the CSI feedback is successfully received. At 2760, after a period of time, the responding AP may send a NDPA to initiate CoBF joint sounding. The NDPA may include a CSI feedback status set to a value to indicate whether the CSI feedback in the last CoBF joint sounding is received successfully or not.

Certain embodiments may include rules and/or conditions associated with receiving cross-BSS CSI. With cross-BSS sounding sequence, an AP needs to overhear a transmission from an OBSS STA which carries the CSI feedback. The frame transmitted by the OBSS STA may be addressed to its own associated AP. In one embodiment, one or more of the following conditions may be met for the initiating or the responding AP to receive the cross-BSS CSI: (1) the cross-CSI is sent in the same TXOP where the CoBF Sounding Invite initiating the sounding sequence is sent; (2) the cross-BSS CSI is sent in a TB PPDU in which the BSS Color in the U-SIG field is the same as the BSS Color in the CoBF Sounding Invite initiating the sounding sequence; (3) the cross-BSS CSI is addressed to the AP which transmitted the NDP PPDU, or which is another AP in the Co—BF coordinated AP pair; and/or (4) the cross-BSS CSI is sent in a sounding sequence including NPDA frame, NDP, BFRP frame and the CSI feedback frame where the NDP frame is transmitted by the AP (the initiating AP or the responding AP).

In some embodiments, initial control frame (ICF)/initial response frames (ICR) may be added to a cross-BSS sounding sequence if the cross-BSS sounding sequence may be in a separate TXOP. The ICF/ICR may be Co—BF sounding invite/response frames, RTS/CTS, MU-RTS/CTS, BSRP/M-BA, etc. For example, the in-BSS sounding sequence may have been performed already. To enable CoBF, the APs may need to perform a cross-BSS sounding sequence. Then, the ICF/ICR frame exchange may be used to protect the cross-BSS sounding sequence.

Some embodiments may include procedure(s) for the mitigation of CSI reception failure. As discussed above, CoBF sounding may be initiated by the initiating AP (AP1) by sending a CoBF sounding invite and the responding AP (AP2) may respond by either accepting or rejecting the invitation. In order to protect the TXOP in which the CoBF sounding will take place, several procedures for setting the NAV, incrementing the NAV setting, and early termination of the sounding sequence may be provided.

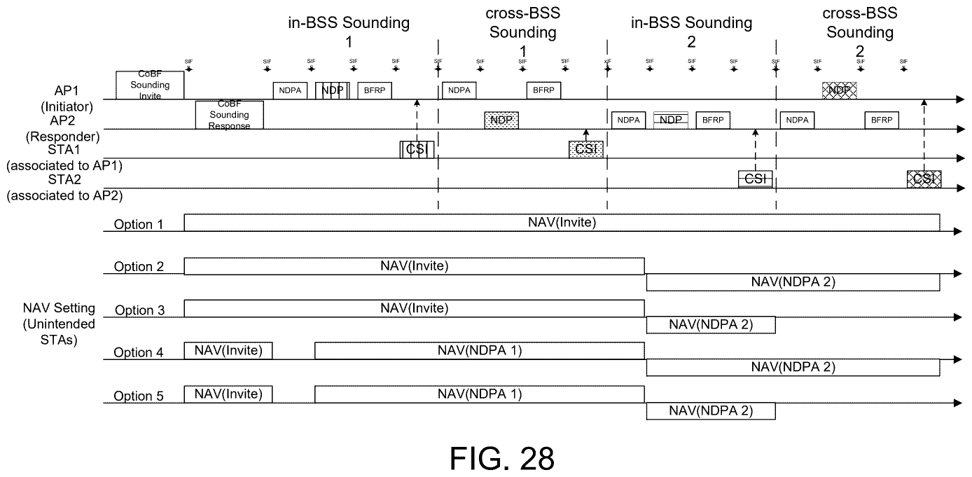

FIG. 28 illustrates an example NAV setting for the CoBF sequential sounding procedure, according to some embodiments. In one embodiment, the NAV setting for the CoBF sequential sounding by the unintended STAs may follow the illustration in FIG. 28. The unintended STAs may include the STAs (e.g., all STAs) associated with AP1, AP2 or any other OBSS but do not include STAs that are selected to participate in the CoBF sounding phase from AP1 (e.g., STA1) and from AP2 (e.g., STA2). For example, STA1 and STA2 may know that they are selected for the CoBF sounding phase on the following occasions: STA1 and STA2 are included in the CoBF Sounding Invite and the CoBF Sounding Response.

In certain embodiments, the duration information in the frames sent in the procedure illustrated in the example of FIG. 28 may consider the following:

### Option1:

Duration(Invite)=CoBFSoundingResponseTime+4NDPATime+4NDPTime+4BFRPTime+4CSITime+16aSIFSTime+aXIFSTime

### Option2:

Duration(Invite)=CoBFSoundingResponseTime+3NDPATime+2NDPTime+2BFRPTime+2CSITime+9aSIFSTime+aXIFSTime

Duration(NDPA2)=NDPATime+2NDPTime+2BFRPTime+2CSITime+7aSIFSTime

### Option3:

Duration(Invite)=CoBFSoundingResponseTime+3NDPATime+2NDPTime+2BFRPTime+2CSITime+9aSIFSTime+aXIFSTime

Duration(NDPA2)=NDPTime+BFRPTime+CSITime+3aSIFSTime

### Option4:

Duration(Invite)=CoBFSoundingResponseTime+2aSIFSTime

Duration(NDPA 1)=NDPATime+2NDPTime+2BFRPTime+2CSITime+7aSIFSTime+aXIFSTime

Duration(NDPA 2)=NDPATime+2NDPTime+2BFRPTime+2CSITime+7aSIFSTime

### Option5:

Duration(Invite)=CoBFSoundingResponseTime+2aSIFSTime

Duration(NDPA 1)=NDPATime+2NDPTime+2BFRPTime+2CSITime+7aSIFSTime+aXIFSTime

Duration(NDPA 2)=NDPTime+BFRPTime+CSITime+3aSIFSTime

In option 1, the initiating AP (AP1) may set the duration of the CoBF Sounding Invite frame to cover the entire duration needed to perform the 4 phases of the CoBF sequential sounding operation (i.e., in-BSS Sounding 1, cross-BSS Sounding 1, in-BSS Sounding 2, cross-BSS Sounding 2). In this option, the assumption is the entire CoBF sequential sounding operation will be performed within the same TXOP and it will be a successful operation.

In one embodiment, if the NAV duration is set according to option 1 and the sounding sequence gets interrupted due to the unsuccessful reception of one or more CSI feedback, the initiating AP may terminate the sounding sequence by sending CF-End frame or any other frame that may be used to truncate the TXOP.

In option 2, the initiating AP (AP1) may set the duration of the CoBF Sounding Invite frame to cover the duration of performing the in-BSS sounding 1 and the cross-BSS sounding 1 and the time needed to send the first NDPA by the responding AP (AP2). If the AP2 received the cross-BSS CSI 1 successfully, then AP2 may set the duration of the NDPA to cover the duration required to complete the in-BSS sounding 2 and the cross-BSS sounding 2.

In option 3, the initiating AP (AP1) may set the duration of the CoBF Sounding Invite frame to cover the duration of performing the in-BSS sounding 1 and the cross-BSS sounding 1 and the time needed to send the first NDPA by the responding AP (AP2). If the AP2 does not receive the cross-BSS CSI 1 successfully, then AP2 may set the duration of the NDPA to cover the duration required to complete the in-BSS sounding 2 only.

In option 4, the initiating AP (AP1) may set the duration of the CoBF Sounding Invite frame to cover the duration needed to send the CoBF Sounding Response frame by the responding AP (AP2). If AP2 responded by accepting the invitation to perform the CoBF sounding, then AP1 may set the duration in the first NDPA to cover the duration needed to perform the in-BSS sounding 1 and the cross-BSS sounding 1 and the time needed to send the first NDPA by the responding AP (AP2). If the AP2 received the cross-BSS CSI 1 successfully, then AP2 may set the duration of the NDPA to cover the duration required to complete the in-BSS sounding 2 and the cross-BSS sounding 2.

In option 5, the initiating AP (AP1) may set the duration of the CoBF Sounding Invite frame to cover the duration needed to send the CoBF Sounding Response frame by the responding AP (AP2). If AP2 responded by accepting the invitation to perform the CoBF sounding, then AP1 may set the duration in the first NDPA to cover the duration needed to perform the in-BSS sounding 1 and the cross-BSS sounding 1 and the time needed to send the first NDPA by the responding AP (AP2). If the AP2 does not receive the cross-BSS CSI 1 successfully, then AP2 may set the duration of the NDPA to cover the duration required to complete the in-BSS sounding only.

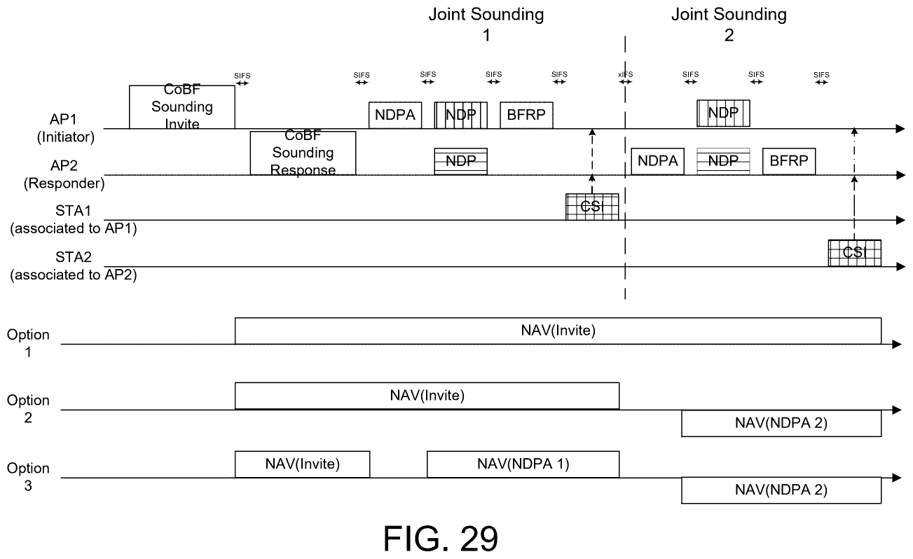

FIG. 29 illustrates an example diagram of a NAV setting for the CoBF joint sounding procedure, according to some embodiments. In an embodiment, the NAV setting for the CoBF joint sounding by the unintended STAs may follow the illustration in the example of FIG. 29. The unintended STAs may include the STAs (e.g., all STAs) associated with AP1, AP2 or any other OBSS but do not include STAs that are selected to participate in the CoBF sounding phase from AP1 (e.g., STA1) and from AP2 (e.g., STA2). For example, STA1 and STA2 may know that they are selected for the CoBF sounding phase on the following occasions: STA1 and STA2 are included in the CoBF Sounding Invite and the CoBF Sounding Response.

In certain embodiments, the duration information in the frames sent in the procedure illustrated in the example of FIG. 29 may consider the following:

### Option1:

Duration(Invite)=CoBFSoundingResponseTime+2NDPATime+2JointNDPTime+2BFRPTime+2JointCSITime+8aSIFSTime+aXIFSTime

### Option2:

Duration(Invite)=CoBFSoundingResponseTime+NDPATime+JointNDPTime+BFRPTime+JointCSITime+5aSIFSTime

Duration(NDPA 2)=NDPATime+2NDPTime+2BFRPTime+2CSITime+7aSIFSTime

### Option3:

Duration(Invite)=CoBFSoundingResponseTime+2aSIFSTime

Duration(NDPA 1)=JointNDPTime+BFRPTime+JointCSITime+3aSIFSTime

Duration(NDPA 2)=JointNDPTime+BFRPTime+JointCSITime+3aSIFSTime

In option 1, the initiating AP (AP1) may set the duration of the CoBF Sounding Invite frame to cover the entire duration needed to perform the 2 phases of the CoBF joint sounding operation (i.e., Joint Sounding 1 and Joint Sounding 2). In this option, the assumption is the entire CoBF JOINT sounding operation will be performed within the same TXOP and it will be a successful operation.

In one embodiment, if the NAV duration is set according to option 1 and the sounding sequence gets interrupted due to the unsuccessful reception of one or more CSI feedback, the initiating AP may terminate the sounding sequence by sending CF-End frame or any other frame that may be used to truncate the TXOP.

In option 2, the initiating AP (AP1) may set the duration of the CoBF Sounding Invite frame to cover the duration of performing the joint sounding 1. If the AP2 received the joint CSI 1 successfully, then AP2 may set the duration of the NDPA to cover the duration required to complete the joint sounding 2.

In option 3, the initiating AP (AP1) may set the duration of the CoBF Sounding Invite frame to cover the duration needed to send the CoBF Sounding Response frame by the responding AP (AP2). If AP2 responded by accepting the invitation to perform the CoBF sounding, then AP1 may set the duration in the first NDPA to cover the duration needed to perform the joint sounding 1 and. If the AP2 received the joint CSI 1 successfully, then AP2 may set the duration of the NDPA to cover the duration required to complete the joint sounding 2.

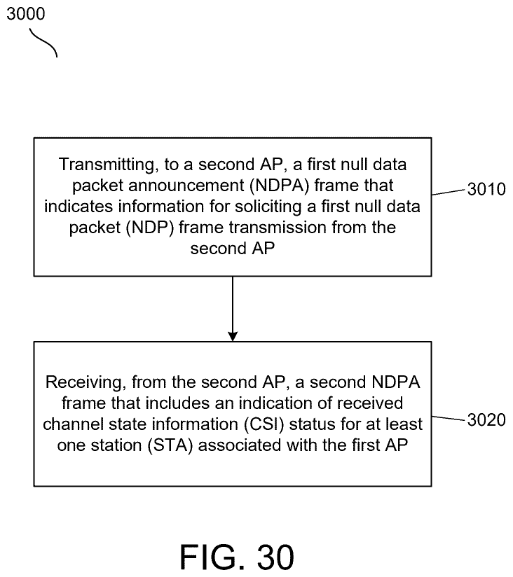

FIG. 30 illustrates an example flow diagram of a method 3000 relating to CoBF in Wi-Fi (e.g., relating to CoBF sounding), according to some example embodiments. The example method 3000 of FIG. 30 and accompanying disclosures herein may include, may be based on, or may be a synthesization of various embodiments or elements discussed in detail above, such as those discussed with respect to FIGS. 6-15. For convenience and simplicity of exposition, the example of FIG. 30 may be described with reference to the architecture or system described above with respect to FIGS. 1A-1D, for instance. However, the example method 3000 depicted in FIG. 30 may be carried out using different architectures as well. According to some embodiments, the method 3000 of FIG. 30 may be implemented by an AP (e.g., Inviting AP, Initiating AP, Initiator AP, Responding AP, Responder AP, AP1 and/or AP2 in the examples of FIGS. 3-29), or the like. In one embodiment, the method 3000 may be implemented by an initiating AP or first AP (e.g., AP1) as illustrated in FIGS. 7-29.

It is noted that the method 3000 of FIG. 30 may include further steps, procedures or details as discussed in detail elsewhere in this disclosure. As such, the method 3000 of FIG. 30 may be modified to include any of the steps, procedures, elements and/or details illustrated and/or discussed in the foregoing. Moreover, it is noted that the method and/or blocks of FIG. 30 may be modified to include, or to be replaced by, any one or more of the procedures, elements or blocks discussed elsewhere herein. As such, one of ordinary skill in the art would understand that FIG. 30 is provided as one example and modifications thereto are possible while remaining within the scope of certain example embodiments as described herein.

As illustrated in the example of FIG. 30, the method 3000 may include, at 3010, the first AP transmitting, to a second AP, a first null data packet announcement (NDPA) frame that indicates information for soliciting a first null data packet (NDP) frame transmission from the second AP. At 3020, the method may include receiving, from the second AP, a second NDPA frame that includes an indication of received channel state information (CSI) status for at least one station (STA) associated with the first AP.

According to an embodiment, the indication of received CSI status may include or may be an indication of whether CSI measurement information, associated with a first CSI, is obtained at the second AP based on the first NDP transmission by the second AP to the at least one STA associated with the first AP.

In some embodiments, the method 3000 may include, based on the indication of received CSI status, re-transmitting the first NDPA including an indication (e.g., cross-BSS sounding indication as shown in FIG. 13 discussed above) that it is a retransmission of the first NDPA. For example, if the indication of received CSI status indicates (e.g., is set to a value to indicate) that the CSI measurement information of the first CSI was not properly obtained at the second AP, then the first AP may re-transmit the first NDPA (or another instance of the first NDPA) and include an indication in the first NDPA that the first NDPA is being sent to initiate or repeat cross-BSS sounding. According to certain embodiments, the retransmission of the first NDPA may be performed in a different TXOP from that of the original transmission of the first NDPA, or it may be performed in the same TXOP as the original transmission of the first NDPA.

In an embodiment, the method 3000 may include transmitting, to the at least one STA, a trigger frame to trigger the at least one STA to send the first CSI, e.g., which may be based on the first NDP transmission.

According to one embodiment, the trigger frame may be a beam forming report poll (BFRP) trigger frame.

According to an embodiment, the method 3000 may include (e.g., when the first AP is a TXOP holder) transmitting, to the second AP, a coordinated beamforming invite frame including information inviting the second AP to participate in coordinated beamforming with the first AP, and receiving, from the second AP, a coordinated beamforming response frame including second information indicating a reason for rejection of participation in the coordinated beamforming with the first AP.

In an embodiment, the method 3000 may include (e.g., when the second AP is a TXOP holder) receiving, from the second AP, a coordinated beamforming invite frame including information inviting the first AP to participate in coordinated beamforming with the second AP.

In some embodiments, the method 300 may also include transmitting, to the second AP, a coordinated beamforming response frame including information indicating that CSI measurement information, associated with a second CSI, was not obtained at the first AP based on a second NDP transmission by the first AP to the at least one STA associated with the second AP (e.g., the first AP may include a reason for rejection in the CoBF response frame to indicate that the first AP did not receive and/or properly decode the measurement information contained in the second CSI).

According to an embodiment, the method 3000 may include sending a CoBF sounding invitation to the second AP, and receiving, from the second AP, a CoBF sounding response including any of: first information indicating a requested frequency associated with receiving CoBF sounding invitations (e.g., a requested maximum number of CoBF sounding invitations during a certain time period), and/or second information indicating a time after which the second AP can receive the CoBF sounding invitations (e.g., the second AP may indicate a time at which it would like to begin to, or will be available to, receive the CoBF sounding invitations).

In an embodiment, the CoBF sounding response may indicate a rejection of the CoBF sounding invitation and/or an indication of a reason for the rejection of the CoBF sounding invitation.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

In some example embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Any characteristic, variant or embodiment described for a method is compatible with an apparatus device comprising means for processing the disclosed method, such as with a device comprising a processor configured to process the disclosed method, a computer program product comprising program code instructions and a non-transitory computer-readable storage medium storing program instructions.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

Although various embodiments have been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although some example embodiments are illustrated and described herein, the invention is not intended to just be limited to the details shown. Rather, various modifications and variations may be made in the details within the scope and range of equivalents of the claims and without departing from the spirit or scope invention.

### REFERENCES

The following references may have been referred to hereinabove, each of which is incorporated herein by reference in its entirety:
IEEE Std 802.11™-2020: Wireless LAN Medium Access Control (MAC) and Physical Layer (PHY) Specifications;
IEEE P802.11ax™/D8.0: Wireless LAN Medium Access Control (MAC) and Physical Layer (PHY) Specifications;
IEEE P802.11be™/D7.0: Wireless LAN Medium Access Control (MAC) and Physical Layer (PHY) Specifications, August 2024;
IEEE P802.11bn™/D0.2: Wireless LAN Medium Access Control (MAC) and Physical Layer (PHY) Specifications, March 2025.

1. A first access point (AP), comprising:
circuitry, including any of a processor and transceiver, configured to
transmit, to a second AP, a first null data packet announcement (NDPA) frame that indicates information for soliciting a first null data packet (NDP) frame transmission from the second AP; and
receive, from the second AP, a second NDPA frame that includes an indication of received channel state information (CSI) status for at least one station (STA) associated with the first AP.

2. The first AP of claim 1, wherein the indication of received CSI status comprises an indication of whether CSI measurement information, associated with a first CSI, is obtained at the second AP based on the first NDP transmission by the second AP to the at least one STA associated with the first AP.

3. The first AP of claim 1, configured to:
based on the indication of received CSI status, re-transmit the first NDPA including an indication that it is a retransmission of the first NDPA.

4. The first AP of claim 2, configured to:
transmit, to the at least one STA, a trigger frame to trigger the at least one STA to send the first CSI based on the first NDP transmission.

5. The first AP of claim 1, configured to:
transmit, to the second AP, a coordinated beamforming invite frame including first information inviting the second AP to participate in coordinated beamforming with the first AP; and
receive, from the second AP, a coordinated beamforming response frame including second information indicating a reason for rejection of participation in the coordinated beamforming with the first AP.

6. The first AP of claim 1, configured to:
receive, from the second AP, a coordinated beamforming invite frame including third information inviting the first AP to participate in coordinated beamforming with the second AP; and
transmit, to the second AP, a coordinated beamforming response frame including fourth information indicating that CSI measurement information, associated with a second CSI, was not obtained at the first AP based on a second NDP transmission by the first AP to the at least one STA associated with the second AP.

7. The first AP of claim 1, configured to:
send a CoBF sounding invitation to the second AP; and
receive, from the second AP, a CoBF sounding response including any of: first information indicating a requested frequency associated with receiving CoBF sounding invitations, and second information indicating a time after which the second AP can receive the CoBF sounding invitations.

8. The first AP of claim 7, wherein the CoBF sounding response indicates a rejection of the CoBF sounding invitation and an indication of a reason for the rejection of the CoBF sounding invitation.

9. A method, implemented by a first access point (AP), the method comprising:
transmitting, to a second AP, a first null data packet announcement (NDPA) frame that indicates information for soliciting a first null data packet (NDP) frame transmission from the second AP; and
receiving, from the second AP, a second NDPA frame that includes an indication of received channel state information (CSI) status for at least one station (STA) associated with the first AP.

10. The method of claim 9, wherein the indication of received CSI status comprises an indication of whether CSI measurement information, associated with a first CSI, is obtained at the second AP based on the first NDP transmission by the second AP to the at least one STA associated with the first AP.

11. The method of claim 9, comprising, based on the indication of received CSI status, re-transmitting the first NDPA including an indication that it is a retransmission of the first NDPA.

12. The method of claim 10, comprising:
transmitting, to the at least one STA, a trigger frame to trigger the at least one STA to send the first CSI based on the first NDP transmission.

13. The method of claim 9, comprising:
transmitting, to the second AP, a coordinated beamforming invite frame including first information inviting the second AP to participate in coordinated beamforming with the first AP; and
receiving, from the second AP, a coordinated beamforming response frame including second information indicating a reason for rejection of participation in the coordinated beamforming with the first AP.

14. The method of claim 9, comprising:
receiving, from the second AP, a coordinated beamforming invite frame including first information inviting the first AP to participate in coordinated beamforming with the second AP; and
transmitting, to the second AP, a coordinated beamforming response frame including fourth information indicating that CSI measurement information, associated with a second CSI, was not obtained at the first AP based on a second NDP transmission by the first AP to the at least one STA associated with the second AP.

15. The method of claim 9, comprising:
sending a CoBF sounding invitation to the second AP; and
receiving, from the second AP, a CoBF sounding response including any of: first information indicating a requested frequency associate with receiving CoBF sounding invitations, and second information indicating a time after which the second AP can receive the CoBF sounding invitations.

16. The method of claim 15, wherein the CoBF sounding response indicates a rejection of the CoBF sounding invitation and an indication of a reason for the rejection of the CoBF sounding invitation.

17. A first access point (AP), comprising:
circuitry, including any of a processor and transceiver, configured to
receive, from a second AP, a first null data packet announcement (NDPA) frame that indicates information for soliciting a first null data packet (NDP) frame transmission; and
transmit, to the second AP, a second NDPA that includes an indication of received channel state information (CSI) status for at least one station (STA) associated with the second AP.

18. The first AP of claim 17, wherein the indication of received channel state information (CSI) status comprises an indication of whether CSI measurement information is obtained at the first AP based on the solicited transmission of the first NDP by the first AP to the at least one STA of the second AP.

19. The first AP of claim 17, configured to:
receive a CoBF sounding invitation from the second AP; and
send, to the second AP, a CoBF sounding response including any of: first information indicating a requested frequency associated with receiving CoBF sounding invitations, and second information indicating a time after which the second AP can receive the CoBF sounding invitations.

20. The first AP of claim 19, wherein the CoBF sounding response indicates a rejection of the CoBF sounding invitation and an indication of a reason for the rejection of the CoBF sounding invitation.
